(19) United States
(12) Patent Application Publication
(10) Pub. No.: US 2003/0105266 A1
(43) Pub. Date: Jun. 5, 2003

(54) Curable resin composition

(76) Inventor: Kazuo Suga, Kanagawa (JP)

Correspondence Address: David T. Nikaido, RADER, FISHMAN & GRAUER, PLLC, Suite 501, 1233 20th Street, NW, Washington, DC, 20036, US

(21) Appl. No.: 10/283,175

(22) Filed: Oct. 30, 2002

(30) Foreign Application Priority Data
Oct. 30, 2001 (JP) 2001-332369
Oct. 31, 2001 (JP) 2001-334254

(51) Int. Cl. C08G 18/80

(52) U.S. Cl. 528/45; 525/404; 525/435

(57) ABSTRACT

A curable resin composition of the present invention has a compound having two or more blocked isocyanate groups where the isocyanate group is blocked by a blocking agent and the dissociation temperature between the isocyanate group and the blocking agent is 140° C. or less, or a compound having two or more free isocyanate groups, and a nylon salt (I), (II) or (III), which has a specific chemical structure, and it has extremely excellent storage stability and low-temperature curing property which are compatible with each other. Also, a curable resin composition which is obtained by allowing the above composition to contain an epoxy compound is provided, so that excellent weatherability is obtained in addition to the storage stability and the low-temperature curing property.

### BACKGROUND OF THE INVENTION

1. Field of the Invention

The present invention relates to a curable urethane resin composition comprising a thermal-latent curing agent. More specifically, the present invention relates to a curable resin composition comprising: a thermal-latent curing agent having a specific nylon salt structure; and a compound having a blocked isocyanate group or a compound having a free isocyanate group, and/or a compound having a specific functional group, having an excellent storage stability, compatible with a property of thermosetting, at a temperature of 140° C. or less preferably in the range of 100° C. to 120° C. (Hereinafter referred to as “low-temperature curing property” in this specification). Furthermore, the present invention relates to a curable resin composition having an excellent storage stability compatible with an excellent low-temperature curing property, and further having an excellent weatherability when comprising a compound having an epoxy group in one of the compositions described above.

2. Description of the Related Art

Urethane resins are widely used in various kinds of products such as elastic urethane rubbers, adhesive agents, coating compositions, fibers, and synthetic leather products. For this reason, curing agents or the like have also been studied for many years and it is well-known that a compound having an active hydrogen such as amine, alcohol, water and the like are used as curing agents. However, in case of one-pot type urethane resin composition there lives a problem that it is difficult to be compatible a storage stability with a property of thermosetting at a temperature of 140° C. or less, preferably in the range of 100° C. to 120° C. because of the existence of the active hydrogen in the form of amine or the like used as a curing agent.

Furthermore, in case of one-pot type urethane resin composition, if one may select a high reactivity compound as described above to use as an active hydrogen compound it is likely that storage stability is degraded. Since isocyanete group is quite active itself, it stands to react with high reactive active hydrogen compounds while storing the urethane composition. On the other hand, if a compound having a low reactivity or a compound having a high thermal dissociation temperature between an isocyanate group and a blocking agent is selected while emphasizing on the storage stability of the above composition, there lives a problem that it is difficult to be compatible a storage stability with the low-temperature curing property due to the difficulty of curing the composition at low temperature.

For allowing the storage stability and the curing property to be compatible with each other, various kinds of thermosetting urethane resin compositions are proposed in the art. For example, JP 5-86164 A discloses a thermosetting composition comprising blocked polyisocyanate which is blocked by a specific blocking agent and polyamine. In this document, for avoiding the reaction between the polyamine with a high reactivity and blocked polyisocyanate, the blocked polyisocyanate may be the one blocked by a specific blocking agent, where the blocked polyisocyanate used may be substantially insoluble in the above described polyamine at room temperature or an appropriately increased temperature to ensure the storage stability of the composition.

For attaining the compatibility between the storage stability and the curing property, for example, JP 10-158353 A discloses a one-pot type thermosetting urethane resin composition that mainly comprises an isocyanate group block polymer which an isocyanate group is protected with phenol or the like and amine. In this document, for securing the storage stability of an urethane composition while still avoiding the reaction between amine also having a high reactivity and the blocked isocyanate group, amine used as a curing agent is fine particle coating amine in which an activated amino group on the surface thereof is coated with a fine particle of 2 μm or less in central particle diameter.

In this one-pot type thermosetting urethane resin composition, however, there is a need to block the isocyanate group of a prepolymer and/or to block an active hydrogen of an active hydrogen compound as a cross linking agent with any component which is not directly related with a crosslinking reaction. In other words, in the case of a composition comprising only a prepolymer having a free isocyanate group (i.e., an isocyanate group without blocking) and an active hydrogen compound to be functioned as a crosslinking agent, storage stability is still sufficient.

Furthermore, each of these compositions has good storage stability when it is stored under comparatively mild conditions at room temperature or at a temperature of 40° C. Therefore, the storage stability is not still satisfied when the composition is used at high temperature in summer or in the environment under which the composition can be actually used.

Furthermore, in JP 2001-48948 A, the applicant of the present invention describes that a one-pot type thermosetting urethane resin composition comprising a prepolymer having a tertiary blocked isocyanate group with a large steric hindrance and a carboxylate of polyamine is compatible storage stability with low-temperature curing property. However, depending on the technological innovations in recent years, compositions with mechanical properties more appropriate to those demanded in manufacturing processes, methods, and products thereof have been required. Then, JP 2001-48948 A discloses a curing composition being compatible storage stability with low-temperature curing property. In this case, however, further improvement in storage stability has been required while keeping the low-temperature curing property as it is.

On the other hand, in the case of an urethane composition, any additional resin component such as an epoxy resin may be added in the composition for improving its heat resistance, weatherability, and so on.

Then, with regard to a one-pot type epoxy resin composition, researches have been conducted to combine storage stability and low-temperature curing property of the composition, and the patents for the technologies thereof has been published. In JP 3007026 B, for example, a thermosetting epoxy resin composition comprising an epoxy resin and a curing agent, where the curing agent is prepared by fixing a specific ratio of fine particles with a specific central diameter on the surface of a curing agent which can be in a solid state at ambient temperature to cover an active group on the surface is described. Also, in this case, the compatibility between storage stability and low-temperature curing property is attained by treating the curing agent with the component which is not directly related with a crosslinking reaction.

In addition, as a thermal-latent curing agent in one-component epoxy resin, it has been known that a specific nylon salt comprised of a diamine having a piperazine ring and a dicarboxylic acid having long-chain methylene group could be effective in terms of heat-resisting adhesiveness, adhesion resistance, and storage stability (Journal of the Adhesion Society of Japan Vol.1, No.1, 1965).

However, the nylon salt curing agent has effective curing property and storage stability on epoxy resins, but it shows insufficient storage stability on thermosetting resins except for epoxy resins such as an urethane resin and an urea resin and also shows an extremely high curing temperature, so that it cannot be used in practice.

The present invention intends to solve the above problems.

Specifically, a first object of the present invention is to provide a curable resin composition comprising: a compound having blocked isocyanate groups; and thermal-latent curing agent comprised a specific nylon salt, having extremely excellent storage stability and excellent thermosetting curing property at a temperature of 140° C. or less, preferably in the range of 100 to 120° C. (in this specification, referred to as “low-temperature curing property”), which are compatible with each other.

Further, the second object of the present invention is to provide a curable resin composition further including an epoxy compound in the composition of the first object, having an excellent weatherability while keeping storage stability and low-temperature curing property in a balanced manner.

Furthermore, the third object of the present invention is to provide a curable resin composition comprising: a compound having a free isocyanate group without being blocked; a compound having vinyl (thio) ether group; and a thermal-latent curing agent comprised a specific nylon salt, with excellent storage stability and excellent low-temperature curing property which are compatible with each other without blocking the isocyanate group.

Further, the fourth object of the present invention is to provide a curable resin composition further including an epoxy compound in the composition of the second object, having an excellent weatherability while keeping storage stability and low-temperature curing property in a balanced manner.

Furthermore, the fifth object of the present invention is to provide a curable resin composition comprising a thermal-latent curing agent only comprised of a component which can be directly involved in three-dimensional crosslinking reaction and a compound having a free isocyanate group without being blocked, with excellent storage stability and excellent low-temperature curing property which are compatible with each other.

Further, the sixth object of the present invention is to provide a curable resin composition further including an epoxy compound in the composition of the fifth object, with an excellent weatherability while keeping storage stability and low-temperature curing property in a balanced manner.

### SUMMARY OF THE INVENTION

As the result of intensive researches on thermal-latent curing agents to be used in urethane resins or the like by the present inventors for may years, the present invention has been completed by finding the facts in which a composition comprising an isocyanate compound having an isocyanate group blocked by a blocking agent and a thermal-latent curing agent comprising a nylon salt with a specific structure has extremely excellent storage stability while keeping its low-temperature curing property as it is.

Also, the present invention has been completed by finding the facts in which a composition comprising the third crosslinking component except an nylon salt as a specific compound and a free isocyanate compound without being blocked has extremely excellent storage stability which is compatible with low-temperature curing property.

Furthermore, the present invention has been completed by finding the facts in which a composition comprising a thermal-latent curing agent including the nylon salt with a specific chemical structure and a compound having a free isocyanate group has excellent storage stability in addition to excellent low-temperature curing property.

Still furthermore, the present invention has been completed by finding the facts in which a composition comprising an epoxy compound in addition to each of the components in the compositions described above has extremely excellent storage stability and low-temperature curing property and improves its weatherability.

Therefore, according to the first aspect of the present invention, it provides a curable resin composition comprising: a compound having two or more blocked isocyanate groups, where an isocyanate group is blocked by a blocking agent and a dissociation temperature in dissociation between the isocyanate group and the blocking agent is 140° C. or less; and at least one nylon salt selected from a group consisting of nylon salts (I), (II), and (III), in which the nylon salt (I) comprises a primary diamine represented by the following formula (1) and dicarboxylic acid represented by the following formula (2):

H₂N—R¹—NH₂ (1)

HOOC—R²—COOH (2)

(where R¹ represents a hydrocarbon group having 8 to 37 carbon atoms, in which a nitrogen atom of an amino group is directly bonded to a carbon atom of aliphatic hydrocarbon; and R² represents a linear hydrocarbon group having 8 to 15 carbon atoms), the nylon salt (II) comprises a piperazine derivative represented by the formula (3) and dicarboxylic acid represented by the following formula (2):

HOOC—R²—COOH (2)

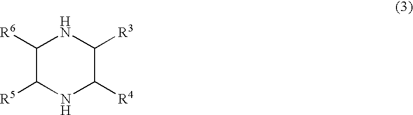

(where R² represents a linear hydrocarbon group having 8 to 15 carbon atoms; and R³ to R⁶ independently represent a hydrogen atom or an alkyl group having 1 to 4 carbon atoms), and the nylon salt (III) comprises a primary diamine represented by the following formula (1) and monocarboxylic acid represented by the following formula (4):

H₂N—R¹—NH₂ (1)

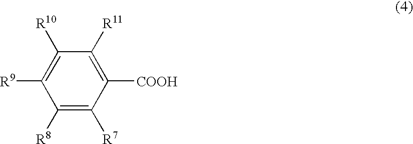

(where R¹ represents a hydrocarbon group having 8 to 37 carbon atoms, in which a nitrogen atom of an amino group is directly bonded to a carbon atom of aliphatic hydrocarbon; R⁷ and R¹¹ independently represent H or OH; R⁸ and R¹⁰ independently represent Cl, Br, I, COOR¹⁷, COR¹⁷, CF₃, CN, SO₂R¹⁷, NO₂, or H; and R⁹ represents Cl, Br, I, COOR¹⁷, COR¹⁷, CF₃, CN, SO₂R¹⁷, H, OH, NR¹⁷₂, or OR¹⁷; and at least one of R⁷ to R¹¹ having the aforementioned substituent except a hydrogen atom, where R¹⁷ represents a hydrocarbon group having 1 to 5 carbon atoms, and plural R¹⁷ can be the same or different).

Accordingly, it becomes possible to provide the curable resin composition having extremely excellent storage stability and low-temperature curing property of an urethane resin having a blocked isocyanate group, and the first object of the present invention can be attained.

Here, the term “nylon salt” used in the present invention is a generic term of a salt comprising diamine extensively possible to prepare polyamide and monocarboxylic acid having a specific substituent, or dicarboxylic acid having a long-chain methylene group, and it does not mean a polyamide compound generated by a dehydrating condensation between diamine and dicarboxylic acid. The nylon salts can be defined as equimolar salts, and alternatively, it may be a salt (compound or mixture) comprising equimolar compounds successively bonded to each other with salt linkages, which will become a polyamide compound by heating condensation.

According to the second aspect of the present invention, it provides a curable resin composition comprising: a compound having the at least one blocked isocyanate group and at least one epoxy group which are respectively included in a molecule thereof, or a mixture of a compound having the two or more blocked isocyanate groups and a compound having two or more epoxy groups; and at least one selected from a group consisting of the nylon salts (I), (II), and (III) described in the first aspect above.

Accordingly, it becomes possible to provide a curable resin composition having excellent weatherability while keeping its storage stability and low-temperature curing property in a balanced manner, and the second object of the present invention can be attained.

According to the third aspect of the present invention, it provides a curable resin composition comprising: a compound having two or more isocyanate groups; a compound having two or more vinyl (thio) ether groups; and at least one selected from a group consisting of the nylon salts (I), (II), and (III) described in the first aspect above.

Accordingly, it becomes possible to provide a curable resin composition which is capable of combining excellent storage stability and low-temperature curing property without blocking an isocyanate group, and the third object of the present invention can be attained.

Furthermore, according to the fourth aspect of the present invention, it provides a curable resin composition comprising: a compound having at least one isocyanate group, at least one vinyl (thio) ether group, and at least one epoxy group, which are respectively included in a molecule thereof, or a mixture of a compound having two or more isocyanate groups, a compound having two or more vinyl (thio) ether groups, and a compound having two or more epoxy groups; and at least one selected from a group consisting of the nylon salts (I), (II), and (III) described in the first aspect above.

Accordingly, it becomes possible to provide a curable resin composition having an excellent weatherability while keeping its storage stability and low-temperature curing property in a balanced manner, and the fourth object of the present invention can be attained.

Also, according to the fifth aspect of the present invention, it provides a curable resin composition comprising: a compound having two or more free isocyanate groups without being blocked; and at least one selected from a group consisting of: a nylon salt (I) comprising a primary diamine represented by the following formula (1) and dicarboxylic acid represented by the following formula (2):

H₂N—R¹—NH₂ (1)

HOOC—R²—COOH (2)

(where R¹ represents a hydrocarbon group having 8 to 37 carbon atoms, in which a nitrogen atom of an amino group is directly bonded to a carbon atom of aliphatic hydrocarbon; and R² represents a linear hydrocarbon group having 8 to 15 carbon atoms); and a nylon salt (III) comprising a primary diamine represented by the following general formula (1) and monocarboxylic acid represented by the following general formula (4):

H₂N—R¹—NH₂ (1)

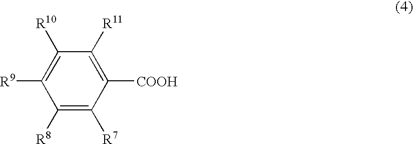

(where R¹ represents a hydrocarbon group having 8 to 37 carbon atoms, in which a nitrogen atom of an amino group is directly bonded to a carbon atom of aliphatic hydrocarbon; R⁷ and R¹¹ independently represent H or OH; R⁸ and R¹⁰ independently represent Cl, Br, I, COOR¹⁷, COR¹⁷, CF₃, CN, SO₂R¹⁷, NO₂, or H; and R⁹ represents Cl, Br, I, COOR¹⁷, COR¹⁷, CF₃, CN, SO₂R¹⁷, H, OH, NR¹⁷₂, or OR¹⁷; and at least one of R⁷ to R¹¹ having the aforementioned substituent except a hydrogen atom, where R¹⁷ represents a hydrocarbon group having 1 to 5 carbon atoms). Thus, the fifth object of the present invention can be attained.

Further, according to the sixth aspect of the present invention, it provides a curing resin composition comprising: a compound having at least one epoxy and at least one free isocyanate group, which are respectively included in a molecule thereof, or a mixture of a compound having two or more free isocyanate groups and a compound having two or more epoxy groups, and the nylon salt (I) or (II) described in the fifth aspect above. Thus, the sixth object of the present invention can be attained.

### DETAILED DESCRIPTION OF THE INVENTION

Hereinafter, the present invention will be described in detail.

According to the first aspect of the present invention, it provides a curable resin composition comprising: a compound (A) that includes two or more blocked isocyanate groups in which each of the isocyanate groups is blocked with a blocking agent and a dissociation temperature between the isocyanate group and the blocking agent is 140° C. or less; and at least one selected from a group consisting of nylon salts (I), (II), and (III) described above.

An isocyanate compound (a) which can be used to produce the compound (A) having two or more blocked isocyanate groups should be a compound having two or more free isocyanate groups (on its terminal ends). The presence of two or more isocyanate groups allows a crosslinking reaction in the respective molecules and/or between molecules to proceed to sufficiently increase the density of crosslinking, while the physical properties of the resulting cured product is also excellent compared with the conventional one.

Such an isocyanate compound (a) comprises:

(a-1) a polyisocyanate compound;

(a-2) a mixture of a polyisocyanate compound and a polyol compound (monomer); and

(a-3) an urethane prepolymer having a free isocyanate group on its terminal end, obtained by reacting a polyol compound (polymer) having an hydroxyl group on a terminal end thereof with an excess amount of a polyisocyanate compound with respect to the hydroxyl group.

Here, the term “free isocyanate group” means an isocyanate group (—NCO group) without being blocked by phenol group or the like. Namely, it is used as a meaning opposite to the “blocked isocyanate group” described above.

The polyisocyanate compound (a-1) and the mixture of the polyisocyanate compound and the polyol compound (monomer) used in the present invention is described below.

Examples of the polyisocyanate compound (a-1) include various kinds of polyisocyanate compounds to be used in the processes of manufacturing the typical polyurethane resins. Specifically, it includes: 2,4-tolylene diisocyanate, 2,6-tolylene diisocyanate, phenylene diisocyanate, xylene diisocyanate, diphenylmethane-4,4′-diisocyanate, naphthalene-1,5-diisocyanate, and hydrogenated compounds thereof, and also includes: ethylene diisocyanate, propylene diisocyanate, tetramethylene diisocyanate, hexamethylene diisocyanate, isophorone diisocyanate, triphenylmethane triisocyanate, and so on.

Examples of the polyisocyanate compound used in the mixture (a-2) of the polyisocyanate compound and the polyol compound (monomer) may include all of the aforementioned polyisocyanate compounds (a-1). In addition, examples of the polyol compound (monomer) include: dihydric alcohols such as ethylene glycol, diethylene glycol, propylene glycol, dipropylene glycol, 1,3-butanediol, 1,4-butanediol, 4,4′-dihydroxyphenylpropane, and 4,4′-dihydroxyphenylmethane; and polyhydric alcohols such as glycerin, 1,1,1-trimethylolpropane, 1,2,5-hexanetriol, and pentaerythritol; and so on.

As to a mixing ratio between the polyisocyanate compound and the polyol compound (monomer), the ratio of isocyanate group to the hydroxyl group, NCO/OH ratio, is in the range of 1.4 to 3.0, preferably of 1.7 to 2.5. If the NCO/OH ratio is less than 1.4, the molecular weight of the resulting mixture may become high enough to extremely increase the viscosity of the polymer. Furthermore, the mechanical strength of the cured product may become low. On the other hand, if the NCO/OH ratio is higher than 3.0, then the mixture often foams while curing and the cured product may become brittle. Therefore, there is the case where any adjustment may be required with an additional compounds that contains an epoxy group, or the like.

The urethane prepolymer (a-3) to be used in the present invention is described below.

The urethane prepolymer (a-3) comprises a polyol compound and an isocyanate compound. Examples of the polyol compound, which is one of the manufacturing raw materials for the urethane prepolymer, include polyether polyol, polyester polyol, other polyols and mixed polyols thereof as in general polyurethane resin compositions.

Examples of polyether polyols include: dihydric alcohols such as ethylene glycol, diethylene glycol, propylene glycol, dipropylene glycol, 1,3-butanediol, 1,4-butanediol, 4,4′-dihydroxyphenylpropane, and 4,4′-dihydroxyphenylmethane; polyhydric alcohols such as glycerin, 1,1,1-trimethylolpropane, 1,2,5-hexanetriol, and pentaerythritol; diamines such as ethylene diamine and aromatic diamines; and polyols obtained by an addition of one or two or more saccharides such as sorbitol, and one or two or more alkylene oxides such as ethylene oxide, propylene oxide, butylene oxide, and styrene oxide.

Examples of polyester polyols include: condensation polymers between one or two or more kinds selected from the group consisting of ethylene glycol, propylene glycol, butanediol, pentanediol, hexanediol, cyclohexane dimethanol, glycerin, 1,1,1-trimethylolpropane or other low-molecular weight polyols, and one or two or more kinds selected from the group consisting of glutaric acid, adipic acid, pimelic acid, suberic acid, sebacic acid, terephthalic acid, isophthalic acid, dimer acid, or other low molecular weight carboxylic acids and oligomeric acid; ring-opening polymers such as propionic lactone and valerolacton; and so on.

The other polyols preferably include: polyols, each of which has a main chain consisting of carbon-to-carbon bonds, such as acryl polyol, polybutadiene polyol, and hydrogenated polybutadiene polyol; and low molecular weight polyols such as ethylene glycol, diethylene glycol, propylene glycole, dipropylene glycol, butanediol, pentanediol, and hexanediol.

Each of these polyol compounds may be used solely or used as a mixture of two or more polyol compounds in the process of manufacturing the urethane prepolymer. In the latter case, a mixing ratio thereof may be optionally defined depending on particular use, storage stability, low-temperature curing property and the physical properties of the cured product, and so on.

Examples of the polyisocyanate compound, which is the other manufacturing raw materials for the urethane prepolymer, include all of the aforementioned polyisocyanate compounds (a-1). Each of these polyisocyanate compounds (a-1) may be solely used or used as a mixture of two or more compounds in the process of manufacturing the urethane prepolymer. In the latter case, a mixing ratio thereof may be optionally defined depending on particular use, storage stability, low-temperature curing property and the physical properties of the cured product, and so on.

The ratio of raw materials in the process of manufacturing the urethane prepolymer is represented by an equivalence ratio (NCO/OH ratio) of an isocyanate group of the polyisocyanate compound to a hydroxyl group of the polyol, which may be in the range of 1.4 to 3.0, preferably in the range of 1.7 to 2.5. If it is within such a range, there is no generation of foams due to the remaining polyisocyanate compound and also there is no increase in the viscosity of the urethane prepolymer due to elongation of a molecular chain. Therefore, the resulting cured product has distinguished physical properties and the storage stability and low-temperature curing property thereof are excellent.

Preferable examples of the urethane prepolymer to be used include those having a number average molecular weight of 400 to 10000 (quantified by gel permeation chromatography (GPC)), more preferably those of 2000 to 7000, because there is no increase in the viscosity of the urethane prepolymer and the physical properties of the cured product are excellent.

The conditions for manufacturing the urethane prepolymer may include those typically used for the conventional urethane polymer without being particularly limited. That is, the reaction can be performed approximately at a reaction temperature of 50 to 100° C. under normal pressure. Alternatively, an urethane-forming catalyst such as an organic tin compound or an organic bismuth compound can be used.

For one of the compositions in accordance with the present invention, a mixture of one or two or more urethane prepolymers (a-3) can be used. In this case, a mixing ratio of the prepolymers may be optionally defined depending on particular use, storage stability, low-temperature curing property and the physical properties of the cured product, and so on.

In addition, for one of the compositions in accordance with the present invention, a mixture of one or more polyisocyanate compounds (a-1) and/or one more mixture (a-2) of polyisocyante compound and polyol compound (monomers) and/or one or more urethane prepolymers (a-3) can be used. In this case, a mixing ratio thereof may be optionally defined depending on particular use, storage stability, low-temperature curing property and the physical properties of the cured product, and so on.

The compound (A) having two or more blocked isocyanate groups used in the present invention is a compound obtained by blocking free isocyanate groups of the aforementioned isocyanate compound (a) with a blocking agent.

The blocking agent is not particularly limited as far as it is generally used for blocking an isocyanate group or the like. Examples of the blocking agent include phenol-, lactam-, oxime-, active methylene-, alcohol-, benzotriazole-, mercaptan-, acid amide-, imide-, amine-, imidazole-, and urea-based blocking agents or the like.

Also, the phenol-based blocking agents include phenol, cresol, xylenol, ethylphenol, and so on. The lactam-based blocking agents include ε-caprolactam, δ-valerolactam, β-butyrolactam, β-propiolactam, and so on. The oxime-based blocking agents include formamide oxime, acetamide oxime, acetoxime, methylethyl ketoxime, diacetyl monoxime, benzophenone oxime, cyclohexanone oxime, and so on. The active methylene-based blocking agents include diethyl malonate, dimethyl malonate, ethyl acetoacetate, methyl acetoacetate, acetyl aceton, and so on. Furthermore, the alcohol-based blocking agents include methanol, ethanol, propanol, isopropanol, butanol, 2-ethylhexanol, ethyleneglycol monomethylether, ethyleneglycol monoethyl ether, ethyleneglycol monobutylether, and so on.

Of those, the phenol-, lactam-, and oxime-based blocking agents are preferable.

A dissociation temperature between an isocyanate group of the blocked isocyanate compound and the blocking agent used in the present invention is 140° C. or less. Within this range, therefore, a composition having extremely excellent storage stability and low-temperature curing property can be obtained. Preferably, such a dissociation temperature may be 120° C. or less, more preferably 100° C. or less.

Specifically, the blocking agents having such a dissociation temperature include ε-caprolactam and methylethyl ketoxime.

Furthermore, the compound (A) having two or more blocked isocyanate groups may include unblocked isocyanate group as far as it ensures the storage stability and early-stage curing property of the resulting composition as one of the objects of the present invention.

Although depending on the isocyanate compound, nylon salt, necessary physical properties and so on, which are used a rate of blocking the free isocyanate group in the resin component is specifically from 0.5 to 1.0, preferably from 0.7 to 1.0, more preferably from 0.8 to 1.0 per equivalent weight of the free isocyanate group. Within this range, if the free isocyanate group is blocked, extremely excellent storage stability can be obtained while keeping low-temperature curing property as it is.

The manufacturing conditions for the above blocking are not particularly limited, and those generally used for the blocking in the art can be included. For instance, blocking is attained such that reaction is performed while stirring a reaction mixture at a temperature of approximately from 50 to 100° C.

The compound (A) having two or more blocked isocyanate groups in accordance with the present invention can be blocked by a single blocking agent or a mixture of two or more blocking agents. Alternatively, different compounds having two or more blocked isocyanate groups being blocked using different blocking agents may be mixed together to obtain the above compound (A). In each of these cases, a mixing ratio thereof may be optionally defined depending on particular use, storage stability, low-temperature curing property and the physical properties of the cured product, and so on.

A nylon salt to be used in the present invention is described below.

The nylon salt is a generic term of salts comprising diamine which can generally form polyamide, and monocarboxylic acid having a specific substituent or dicarboxylic acid having a long-chain methylene group, and it does not mean a polyamide compound generated by a dehydrogenation condensation between diamine and dicarboxylic acid. The nylon salt is defined as one comprising equimolar salts, but it may be successively bonded using salt linkages, and is a salt (compound or mixture) which can become a polyamide compound by thermal condensation.

<Nylon Salt (I)>

Primary diamine which is one of the raw materials for the production of nylon salt (I) isadiamine in which a nitrogen atom of each of amino groups is directly bonded to a carbon atom of an aliphatic hydrocarbon in a hydrocarbon group having 8 to 37 carbon atoms represented by the aforementioned general formula (1). The hydrocarbon group having 8 to 37 carbon atoms is a linear hydrocarbon group or an alicyclic hydrocarbon group, and it can contain aromatic rings in each of these groups, respectively. Furthermore, a nitrogen atom of the amino group does not directly bond to the aromatic ring.

Using the primary diamine facilitates the production of nylon salt (I), while combining storage stability and low-temperature curing property. If it is a diamine which is directly bonded to a carbon atom of the aliphatic hydrocarbon, a crosslinking reaction can be performed at low temperature after thermal dissociation of the nylon salt (I), and the storage stability of the resulting composition is excellent. Furthermore, if the number of carbons of the hydrocarbon group is in the above range, excellent storage stability and low-temperature curing property can be attained.

Examples of such amines include, although not particularly limited thereto, 1,8-diaminooctane; 1,9-diaminononane; 1,10-diaminodecane; 1,11-diaminoundecane; 1,12-diaminododecane; 1,3-cyclohexane bis(methylamine); 1,3-cyclohexane bis(ethylamine); o-, m-, or p-xylylene diamine; the so-called adduct-denatured amine prepared by reacting the amine with a glycidyl ether epoxy resin obtained by reacting epichlorohydrin with bisphenol A, bisphenol F, glycerin, neopentyl glycol, propylene glycol, or the like. The adduct-denatured amine may be used solely or as a mixture with the above amine.

For attaining the compatibility between excellent storage stability and excellent low-temperature curing property, o-, m-, or p-xylylene diamine, 1,8-diaminooctane, 1,10-diaminodecane, 1,12-diaminododecane, or 1,3-cyclohexane bis(methylamine) may be preferably used solely or may be used in combination with a bisphenol A glycidyl ether or neopentyl glycidyl ether adduct-denatured compound of such amines. Of those, m- or p-xylylene diamine having an aromatic ring is more preferable.

Dicarboxylic acid as the other raw material for the production of nylon salt (I) is an aliphatic dicarboxylic acid having 10 to 17 carbon atoms in total in which a carboxyl group is bonded to each of the opposite terminal ends of a linear hydrocarbon group R² having 8 to 15 carbon atoms as represented by the above general formula (2).

The presence of the hydrocarbon group with a long-chain methylene group having 8 to 15 carbon atoms facilitates the generation of nylon salt (I), permitting the compatibility between storage stability and low-temperature curing property.

The examples of such a dicarboxylic acid are not particularly limited thereto and may specifically include sebacic acid (decane diacid), undecane diacid, dodecane diacid, tridecane diacid, tetradecane diacid, pentadecane diacid, hexadecane diacid, and heptadecane diacid. In terms of storage stability, low-temperature curing property, availability, and so on, sebacic acid, dodecane diacid, tetradecane diacid, and hexadecane diacid are preferable because they have an even number of carbon atoms in the hydrocarbon group. Of those, dodecane diacid is preferable in particular.

The nylon salt (I) may be of any combination of the dicarboxylic acid and the diamine described above. For instance, examples of such a combination include: p-xylylenediamine and sebacic acid, p-xylylenediamine and dodecane diacid, p-xylylenediamine and tetradecane diacid, p-xylylenediamine and hexadecane diacid; 1,8-octanediamine and sebacic acid, 1,8-octanediamine and dodecane diacid, 1,8-octanediamine and tetradecane diacid, 1,8-octanediamine and hexadecane diacid; 1,10-diaminodecane and sebacic acid, 1,10-diaminodecane and dodecane diacid, 1,10-diaminodecane and tetradecane diacid, 1,10-diaminodecane and hexadecane diacid; 1,12-diaminododecane and sebacic acid, 1,12-diaminododecane and dodecane diacid, 1,12-diaminododecane and tetradecane diacid, 1,12-diaminododecane and hexadecane diacid; 1,3-cyclohexane bis(ethylamine) and sebacic acid, 1,3-cyclohexane bis(ethylamine) and dodecane diacid, 1,3-cyclohexane bis(ethylamine) and tetradecane diacid, 1,3-cyclohexane bis(ethylamine) and hexadecane diacid, and so on. In terms of storage stability, low-temperature curing property, and availability, and the like, m-xylylenediamine and sebacic acid, m-xylylenediamine and dodecane diacid, m-xylylenediamine and tetradecane diacid, m-xylylenediamine and hexadecane diacid; p-xylylenediamine and sebacic acid, 1,8-octanediamine and sebacic acid, 1,10-diaminodecane and sebacic acid, 1,12-diaminododecane and sebacic acid, 1,3-cyclohexane bis(ethylamine) and sebacic acid, and so on are preferable. Of those, the combination of m-xylylenediamine and dodecane diacid is specifically preferable.

<Nylon Salt (II)>

One of the diamines used as a raw material for the production of nylon salt (II) is a piperazine derivative represented by the above general formula (3). If it is a piperazine derivative, the production of nylon salt (II) can be facilitated while permitting the compatibility between storage stability and low-temperature curing property. In addition, a crosslinking reaction can be performed at low temperature after thermal dissociation of the nylon salt (II).

Examples of such a piperazine derivative include, although not particularly limited thereto, piperazine, 2-methylpiperazine, 2-ethylpiperazine, 2-propylpiperazine, 2-butylpiperazine, 2,5-dimethylpiperazine, 2,6-dimethylpiperazine, 2-aminomethylpiperazine, homopiperazine, and so on (further including their respective variants).

Of those, piperazine, 2-methylpiperazine, and 2-aminomethylpiperazine are specifically preferred for combining excellent storage stability and low-temperature curing property.

Dicarboxylic acid as the other raw material for the production of nylon salt (II) is the same as the dicarboxylic acid (represented by the general formula (2)) having the long-chain methylene group in the aforementioned nylon salt (I). Specifically, all of the above examples of dicarboxylic acid for the aforementioned nylon salt (I) can be used for the nylon salt (II).

The nylon salt (II) may be prepared by any combination of a piperazine derivative and the above dicarboxylic acid. For example, the combinations include piperazine and sebacic acid, piperazine and dodecane diacid, piperazine and tetradecane diacid, piperazine and hexadecane diacid, and 2-methylpiperazine and dodecane diacid.

In terms of storage stability, low-temperature curing property, availability, and so on, piperazine and sebacic acid, piperazine and dodecane diacid, and 2-methylpiperazine and dodecane diacid are preferable.

<Nylon Salt (III)>

Primary diamine as one of the raw materials for the production of nylon salt (III) is the same diamine as the one represented by the above formula (1) used in nylon salt (I). Specifically, all of the above examples of diamine for the aforementioned nylon salt (I) can be also used for the nylon salt (III).

The diamine having the above general formula (1) facilitates the production of nylon salt (II) while permitting the compatibility between storage stability and low-temperature curing property. In addition, when it is a diamine which is directly bonded to a carbon atom of the aliphatic hydrocarbon, a crosslinking reaction can be performed at low temperature after thermal dissociation of the nylon salt (III).

Monocarboxylic acid having a specific substituent as the other raw material for the production of nylon salt (III) is a benzoate derivative having the above general formula (4). Preferably, a substituent on a phenyl group of the benzoate may have, although not particularly limited thereto, a hydrogen atom, a hydroxyl group capable of making a hydrogen bond with a carboxyl group, or the like on its ortho position (each of R⁷ and R¹¹ of the above formula (4)). Furthermore, a meta position thereof (each of R⁸ and R¹⁰ of the above formula (4)) is preferably a hydrogen atom or an electron-attracting group and a para position thereof (R⁹ of the above formula (4)) is preferably an electron-attracting group or an electron-donating group such as an alkoxy group or a hydroxyl group. Due to the presence of such a benzoate derivative, excellent storage stability and low-temperature curing property can be attained in a compatible manner.

The introduction of such substituent permits the increase in acidity (the ability of dissociation) and steric hindrance of the benzoate. Thus, it is considered that excellent storage stability can be compatible with excellent low-temperature curing property as the result of decrease in the reactivity between a nylon salt-forming portion and an active group such as an isocyanate group.

Examples of such benzoates include, although not particularly limited thereto, salicylic acid, 3-chloro benzoate, 3-methylcarbonyl benzoate, 3-trifluoro benzoate, 4-anisic acid, 4-chloro benzoate, 4-nitro benzoate, 4-methylcarbonyl benzoate, 4-cyano benzoate, 4-trifluoro benzoate, 3,5-dichloro benzoate, 3,4-dichloro benzoate, and so on. In terms of storage stability, low-temperature curing property, and availability, 4-chloro benzoate, 4-anisic acid, 4-nitro benzoate, and 4-cyano benzoate are preferable. Of those, 4-chloro benzoate is particularly preferable.

The nylon salt (III) may be any combination of the above monocarboxylic acid and diamine. Examples of such a combination include m-xylylene diamine and 4-anisic acid, m-xylylene diamine and 4-chloro benzoate, and m-xylylene diamine and salicylic acid. In terms of storage stability, low-temperature curing property, availability, and so on, the combination of m-xylylene diamine and 4-anisic acid, and the combination of m-xylylene diamine and 4-chloro benzoate are preferable.

In the first aspect of the present invention, at least one nylon salt selected from a group consisting of the nylon salts (I), (II), and (III) is used as a thermal-latent curing agent.

In other words, one or two or more nylon salts (I) can be used solely or as a combination thereof, and the same apply for the nylon salts (II) and (III). Alternatively, the nylon salts (I), (II), and (III) can be used by mixing them together. In this case, for each of the mixtures, a mixing ratio thereof may be optionally defined depending on particular use, storage stability, low-temperature curing property and the physical properties of the cured product, and so on.

The process of manufacturing nylon salt is not particularly limited. For instance, it may include the steps of mixing diamine and carboxylic acid in water or alcohol such as methanol (the equivalent weight of a carboxyl group of the carboxylic acid per amino group of the diamine is from 1.00 to 1.05), followed by standing or cooling the resultant to obtain the deposition of nylon salt.

The resulting nylon salt is water-soluble and is also very stable at room temperature. In addition, the nylon salt cannot be dissociated and dissolved by absorbing moisture from the air.

The content of the nylon salt (I) comprised in the curable resin composition described in the first aspect of the present invention is from 2 to 60 parts by weight, preferably from 5 to 50 parts by weight, more preferably from 10 to 30 parts by weight with respect to 100 parts by weight of the compound (A) having two or more blocked isocyanate groups.

The content of the nylon salt (II) is from 2 to 60 parts by weight, preferably from 5 to 50 parts by weight, more preferably from 10 to 30 parts by weight with respect to 100 parts by weight of the compound (A) having two or more blocked isocyanate groups.

The content of the nylon salt (III) is from 2 to 60 parts by weight, preferably from 5 to 50 parts by weight, more preferably from 15 to 30 parts by weight with respect to 100 parts by weight of the compound (A) having two or more blocked isocyanate groups.

Within this range, excellent storage stability and low-temperature curing property can be compatible with each other.

The curable resin composition of the first aspect of the present invention can include one polymer or a mixture of two or more polymers except the compounds of the present invention within a range that does not impair the object of the present invention. If required, the above composition may further comprise at least one of a plasticizer, a filler, a catalyst, a solvent, a UV absorbent, a dye, a pigment, a fire retardant, a reinforcing agent, an antiaging agent, an antioxidant, a thixotropy imparting agent, a surfactant (including leveling agent), a dispersing agent, a dehydrating agent, a rust-preventive agent, an adhesion providing agent, an antistatic agent, and so on.

The above polymers except the compounds of the present invention specifically include, although not particularly limited thereto, thermoplastic resins such as polyethylene (PE), polypropylene (PP), and polystyrene (PS); thermosetting resins such as phenol resin, epoxy resin, and polyurethane resin; thermoplastic elastomer such as styrene-, vinyl chloride-, urethane-based elastomer; thermosetting elastomers such as silicon- and urethane-thermosetting elastomers; natural rubber; synthetic rubber such as isoprene rubber (IR), butadiene rubber (BR), styrene-butadiene rubber (SBR), butyl rubber (IIR), chloroprene rubber (CR), and ethylene propylene rubber (EPM, EPDM); specific rubber such as acrylonitrile-butadiene rubber (NBR); and so on. Since the present invention provides the curable resin composition comprises the crosslinking agent, it is preferable that the polymer other than those used in the compounds of the present invention is the thermosetting resin which can be cured with diamine or carboxylic acid. The content of such a polymer is from 2 to 100 parts by weight, preferably from 5 to 50 parts by weight with respect to 100 parts by weight of the compound (A) having two or more blocked isocyanate groups.

Examples of the plasticizer include derivatives of benzoate, phthalic acid, trimellitic acid, pyromellitic acid, adipic acid, sebacic acid, fumaric acid, maleic acid, itaconic acid, citric acid, and so on, polyester, polyether, epoxy-, paraffin-, and naphthene-, and aromatic-based process oils, and so on. The content of the plasticizer is from 5 to 100 parts by weight, preferably from 10 to 30 parts by weight with respect to 100 parts by weight of the compound having two or more blocked isocyanate groups.

Examples of the filler include, titanium dioxide, carbon black, fumed silica, calcinated silica, precipitated silica, pulverized silica, molten silica, silicate derivative, diatomaceous earth, talc, metal powder, iron oxide, zinc oxide, titanium oxide, barium oxide, magnesium oxide, calcium carbonate, magnesium carbonate, zinc carbonate, roseki clay, kaolin clay, calcinated clay, surface-treated products thereof, and so on. The content of the filer is from 1 to 100 parts by weight, preferably from 5 to 50 parts by weight with respect to 100 parts by weight of the compound having two or more blocked isocyanate groups.

Examples of the catalyst include: metal catalysts such as dibutyl tin dilaurate, dioctyl tin laurate, zinc octyl acid, and organic bismuth compounds; amine catalysts such as triethylene diamine, and morpholine-based amines; and so on. The content of the catalyst is from 0.01 to 3 parts by weight, preferably 0.05 to 1 part by weight with respect to 100 parts by weight of the compound having two or more blocked isocyanate groups.

The antiaging agent, for example, may be a hindered phenol-based compound, or an aliphatic or aromatic hindered amine-based compound.

The antioxidant, for example, may be butyl hydroxytoluene (BHT), butyl hydroxyanisole (BHA), or the like.

Examples of the pigments include: inorganic pigments such as titanium dioxide, zinc oxide, ultramarine blue, iron oxide red, lithopone, lead, cadmium, iron, cobalt, aluminum, hydrochloride, and sulfate; and organic pigments such as azo pigment, phthalocyanine pigment, quinacridone pigment, quinacridonquinone pigment, dioxazine pigment, anthrapyrimidine pigment, anthanthrone pigment, indanthrone pigment, flavanthrone pigment, perylene pigment, perynone pigment, diketopyrrolo pyrrole pigment, quinonaphthalone pigment, anthraquinone pigment, thioindigo pigment, benzimidazolone pigment, isoindrin pigment, carbon black, and so on.

Examples of the thixotropy imparting agent include bentonite, silicic anhydride, silicic acid derivatives, urea derivatives, and so on.

Examples of the UV absorbant include 2-hydroxy benzophenone-based, benzotriazole-based, or salicylic acid ester-based UV absorbent, and so on.

Examples of the flame retardant include phosphorus flam retardants such as TCP, halogen flame retardants such as chlorinated paraffin and perchloropentacyclodecane, antimony flame retardants such as antimony oxide, aluminum hydroxide, and so on.

Examples of the solvent include those mainly comprised of hydrocarbons such as hexane and toluene; halogenated hydrocarbons such as tetra chloromethane; ketones such as acetone and methylethylketone; ethers such as diethyl ether and tetrahydrofran; esters such as ethyl acetate; alcohols such as methanol and ethanol; and so on.

Examples of the surfactant (leveling agent) include polybutyl acrylate, polydimethyl siloxane, denatured silicone compounds, fluorochemical surfactants, and so on.

Examples of the dehydrating agent include vinylsilane and so on.

Examples of the rust preventive agent include zinc phosphate, tannic acid derivatives, phosphate, basic sulfonate, various kinds of rust preventive pigments, and so on.

Examples of the adhesion providing agent include well-known silane-coupling agents, silane compounds having an alkoxy silyl group, titanium coupling agents, zirconium coupling agents, and so on. Specifically, examples thereof include trimethoxy vinylsilane, vinyl triethoxysilane, vinyl tris(2-methoxyethoxy) silane, γ-methacryloxy propyl trimethoxy silane, 3-glycidoxypropyl trimethoxy silane, and so on.

Examples of the antistatic agent generally include quaternary ammonium salts, or hydrophilic compounds such as polyglycols, ethylene oxide derivatives, and so on.

The content of each of various additives described from the antiaging agent to the antistatic agent is from 0.01 to 5 parts by weight, preferably from 0.05 to 2 parts by weight with respect to 100 parts by weight of the compound having two or more blocked isocyanate groups.

One of the examples of the process for manufacturing the curable resin composition of the first aspect is that in the process, at first, a predetermined amount of the compound (A) having two or more blocked isocyanate groups is placed in a kneader into which nitrogen gas is charged. If required, one or more additional components such as a plasticizer and a filler may be also placed in the kneader. After that, nylon salt is placed in the kneader, followed by sufficiently mixing the mixture at low temperature (from room temperature to 40° C.) under reduced pressure. The resulting curable resin composition may be used as it is. Alternatively, the resulting curable resin composition may be sealed and cooled after filling in a container to store the composition.

Examples of the application of the curable resin composition of the first aspect include coating compositions, adhesive agents, sealing agents, other molded products, and so on. In particular, as the curable resin composition has low-temperature curing property, it can be appropriately used as an adhesive composition for attaching interior decoration products such as plastic parts on a steel plate in the vehicle production.

The thermosetting resin composition of the first aspect is a thermosetting resin composition capable of becoming an urethane polymer as follows. When the composition is heated, each of the nylon salts (I), (II), and (III) in the composition can be thermally dissociated at a temperature of approximately 80 to 100° C., releasing diamine and carboxylic acid. In addition, the blocked isocyanate group of the resin composition can be thermally dissociated into the free isocyanate group and the blocking agent at 140° C. or less. Then, each of them participates in a three-dimensional crosslinking reaction with a free isocyanate group generated from the compound having two or more blocked isocyanate groups. That is, the blocked isocyanate compound functions as a thermal-latent isocyanate group containing compound, while the nylon salt functions as a thermal-latent curing agent, so that the composition becomes an urethane polymer.

As described above, the nylon salts (I), (II), and (III) in the composition can be thermally dissociated at a low temperature in the range of approximately 80 to 100° C., while the blocked isocyanate group is regulated so as to be thermally dissociated at a temperature near the above range to participate in a three-dimensional crosslinking reaction, so that the composition has excellent low-temperature curing property.

The curing agent which has been known in the prior art can be thermally dissociate at low temperature, so that a three-dimensional crosslinking reaction can gradually proceed before reaching a thermally curing temperature and the storage stability of thereof can be poor. In the case of nylon salt of the present invention, the thermal dissociation thereof is hardly occurred at a temperature less than the thermal dissociation temperature. In addition, it does not cause the three-dimensional crosslinking reaction, so that excellent storage stability of the composition can be obtained. Furthermore, the isocyanate group is being blocked, so that the conditions of storing the composition becomes hard. Therefore, the three-dimensional crosslinking reaction is hardly progressed even though a part of the nylon salts is thermally dissociated, exerting extremely excellent storage stability.

The second aspect of the present invention is a curable resin composition comprising a compound (B) in which at least one blocked isocyanate group described above and at least one epoxy group which are respectively included in a molecule thereof, or a mixture of a compound (A) having two or more blocked isocyanate groups described above and a compound (c) having two or more epoxy groups; and at least one selected from a group consisting of the aforementioned nylon salts (I), (II), and (III).

Here, the compound (B) which has at least one blocked isocyanate group described above and at least one epoxy group in a molecule thereof is a compound (monomer, B-1) having these groups in the molecule and/or a prepolymer (B-2) having these groups in the molecule.

In addition, the mixture of the compound (A) having two or more blocked isocyanate groups and the compound (c) having two or more epoxy groups refers to the mixture of the above compound (A) and the compound (c) having two or more epoxy groups.

A crosslinking reaction can occur in the molecule and/or between the molecules if there is provided the composition (B) in which at least one epoxy group and at least one blocked isocyanate group used in the present invention are included in each molecule. As a result, the composition can be cured.

Examples of the compound (B) include a monomer (B-1) obtained by blocking a reaction product between an epoxy compound having a hydroxyl group and a polyisocyanate compound with a blocking agent.

Examples of the polyisocyanate compound may employ all of the polyisocyanate compounds (a-1) described above.

Examples of the epoxy compound having a hydroxyl group include, although not particularly limited thereto, glycidol, glycerol diglycidyl ether, sorbitol polyglycidylether, trimethylolpropane diglycidylether, polypropylene glycol monoglycidyl ether, polyethylene glycol monoglycidyl ether, glycerol diglycidyl ether, bisphenol-A monoglycidyl ether, bisphenol-S monoglycidyl ether, diglycidyl amino phenol, (2S, 3S)-3-phenyl glycidol, and so on.

Of those, glycidol and gryceroldiglycidyl ether are preferable because each of them has a low viscosity and a high reactivity with an isocyanate compound, so that the monomer (B-1) can be easily obtained.

For obtaining an unblocked compound of the monomer (B-1) by the reaction between the polyisocyanate compound (a-1) and the epoxy compound having the hydroxyl group, an excess amount of the polyisocyanate compound may be used and the reaction may be then performed under typical conditions. In addition, the blocking process can be performed under the above conditions.

Furthermore, examples of the compound (B) include the prepolymer (B-2) in which at least one epoxy group and at least one blocked isocyanate group are included in each of the molecules.

Such a polymer can be obtained in the process for manufacturing urethane prepolymer, where an epoxy polyol is used and a free isocyanate group thereof is blocked by a blocking agent. On the other hand, a denatured prepolymer can be obtained by grafting the prepolymer having one of the above groups with a side chain having the other of the above groups. Alternatively, both prepolymers may be copolymerized.

Examples of the epoxy polyol specifically include, although not particularly limited thereto, epoxy polyols of bisphenol-A-based, glycidyl ether-based, and so on; epoxy compounds having the above hydroxyl group; and so on. The manufacturing process thereof specifically include, although not particularly limited thereto, the step of reacting the epoxy resin of bisphenol-A-based, glycidyl ether-based, or the like, having epoxy groups on its opposite terminal ends with monoethanol amine, diethanol amine, or the like under the reaction conditions generally used in the art.

The isocyanate compound to be reacted with the epoxy polyol may be selected from all of the polyisocyanate compounds (a-1) described above.

For the blocking agent used for the above compounds (B-1) and (B-2), all of the blocking agents described above may be used. In addition, a rate of blocking the isocyanate group with the blocking agent is from 0.5 to 0.99, preferably from 0.7 to 0.98, more preferably from 0.8 to 0.98 per equivalent weight of the free isocyanate group. Within this range, if the free isocyanate group is blocked, extremely excellent storage stability can be obtained while keeping low-temperature curing property as it is.

With regard to the molecular weight of the prepolymer (B-2), in which at least one epoxy group and at least one blocked isocyanate group are included in each molecule thereof, using a monomer with a number average molecular weight of 400 to 1000 quantified by gel permeation chromatography (GPC) is preferable, and more preferably of 2000 to 7000 is used, because there is no increase in the viscosity of the prepolymer and the physical properties of the cured product is excellent.

Furthermore, the prepolymer may be used solely or used as a mixture of two or more prepolymers. In this case, a mixing ratio thereof may be optionally defined depending on particular use, storage stability, low-temperature curing property and the physical properties of the cured product, and so on.

The conditions for manufacturing the prepolymer is not particularly limited and may be those used for manufacturing the conventional urethane prepolymer. That is, the reaction can be performed at a temperature of approximately 50 to 100° C. under normal pressure. Furthermore, urethane-forming catalyst such as an organic tin compound and an organic bismuth compound may be also used.

Subsequently, the reaction is performed under the above blocking conditions using the above blocking agent, resulting in a blocked urethane prepolymer.

The denatured prepolymer obtained by grafting the prepolymer having one of the above groups with a side chain having the other of the above groups and the prepolymer obtained by copolymerizing both prepolymers are not specifically limited, respectively. The manufacturing conditions thereof may also be those generally used in the art. For example, there is a process in which an addition reaction between two equivalent weight of bisphenol-A glycidyl ether and less than one equivalent weight of monoethanol amine or diethanol amine is performed to elongate the chain, a hydroxyl group generated by the addition reaction is then reacted with a polyisocyanate compound, followed by finally blocking the free isocyanate group with a blocking agent.

The compound (B) in which at least one epoxy group and one blocked isocyanate group are included in each molecule can be used by mixing with one or more compounds (B-1) in which the above groups are included in each molecule thereof and one or more prepolymers (B-2) in which the above groups are included in each molecule thereof. In this case, a mixing ratio thereof may be optionally defined depending on particular use, storage stability, low-temperature curing property and the physical properties of the cured product, and so on.

The mixture between the compound (A) having two or more blocked isocyanate groups and the compound (c) having two or more epoxy groups is a mixture between the compound (A) and the compound (c) having two or more epoxy groups. Examples of the compound having two or more blocked isocyanate groups may be all of the compounds (A) described above.

In the case of the compound having two or more blocked isocyanate groups, if the isocyanate group, is blocked by the blocking agent at a blocking rate of 1.0 (100%) per one equivalent weight of the free isocyanate group, the compound (a) having two or more free isocyanate groups may be additionally included as the mixture within the range that does not impair the object of the present invention.

The compound (c) having two or more epoxy groups includes a polyepoxy compound (monomer, c-1) and the prepolymer (c-2) having two or more epoxy groups.

Threfore, the compound (c) is required to have two or more epoxy groups.

Specific examples of the polyepoxy compound (monomer, c-1) include, although not particularly limited thereto, phthalic acid diglycidyl ester, tetrahydrophthalic acid diglycidyl ester, hexahydrophthalic acid diglycidyl ester, N,N-diglycidyl amine, tetraglycidyl diaminodiphenylmethane, diglycidyl bisphenol-A, glycerol triglycidyl ether, trimethylolpropanetriglycidyl ether, polypropylene glycol diglycidyl ether, polyethylene glycol diglycidyl ether, and so on. Of those, diglycidyl bisphenol-A and glycerol triglycidyl ether are preferable because of their low viscosity and high reactivity.

The prepolymer (c-2) having two or more epoxy groups is not particularly limited, and specifically, may be an epoxy resin which is one selected from: glycidyl ether epoxy resin prepared by reacting epichlorohydrin with polyphenol such as bisphenol-A, bisphenol-F, bisphenol-S, hexahydro bisphenol-A, tetramethyl bisphenol-A, pyrocatechol, resorcinol, cresol novolac, tetrabromo bisphenol-A, trihydroxy biphenyl, bis resorcinol, bisphenol hexafluoroacetone, tetramethyl bisphenol-F, or bixylenol; polyglycidyl ether epoxy resin prepared by reacting epichlorohydrin with aliphatic polyhydric alcohol such as glycerin, neopentyl glycol, ethylene glycol, propylene glycol, butylene glycol, hexylene glycol, polyethylene glycol, or polypropylene glycol; glycidyl ether ester epoxy resin prepared by reacting epichlorohydrin with hydroxy carboxylic acid such as p-oxybenzoate or β-oxynaphthoic acid; polyglycidyl ester epoxy resin derived from polycarboxylic acid such as phthalic acid, methylphthalic acid, isophthalic acid, terephthalic acid, tetrahydrophthalic acid, hexahydrophthalic acid, endo-methylene tetrahydrophthalic acid, endo-methylene hexahydrophthalic acid, trimellitic acid, or polymerized fatty acid; glycidyl aminoglycidyl ether epoxy resin derived from aminophenol, aminoalkyl phenol, or the like; glycidyl aminoglycidyl ester epoxy resin derived from mono benzoate; glycidyl amine epoxy resin derived from aniline, toluidine, tribromaniline, xylylenediamine, diaminocyclohexane, bisaminomethyl cyclohexane, 4,4′-diaminodiphenylmethane, 4,4′-diamino diphenyl sulfone, or the like; epoxidized polyolefin, glycidyl hydantoin, glycidyl alkylhydantoin, triglycidyl cyanurate, or the like; monoepoxy compound such as butylglycidyl ether, phenyl glycidyl ether, alkyl phenyl glycidyl ether, benzoate glycidyl ester, or styrene oxide; and a mixture of one or two or more compounds described above. In this case, a mixing ratio thereof may be optionally defined depending on particular use, storage stability, low-temperature curing property and the physical properties of the cured product, and so on.

Among the compounds described above, because of its low viscosity and high reactivity, the glycidyl ether epoxy resin (bisphenol-A polyglycidyl ether, bisphenol-F polyglycidyl ether) obtained by reacting with bisphenol-A or bisphenol-F is preferable.

Furthermore, an epoxy-denatured prepolymer in which a compound having an epoxy group is grafted on the side chain thereof may also be used.

Such epoxy prepolymer or epoxy-denatured prepolymer to be used is preferably one having a number average molecular weight of 400 to 10000 quantified by gel permeation chromatography (GPC), more specifically of 2000 to 7000, because of its viscosity which can be easily handled and good physical properties of the cured product.

The mixture of the compound (A) having two or more blocked isocyanate groups and the compound (c) having two or more epoxy groups may be used by mixing one or more compounds obtained by blocking one or more compounds (a-1), (a-2), and (a-3) having two or more blocked isocyanate groups and one or more epoxy compounds (monomer (c-1), and prepolymer (c-2)). In this case, a mixing ratio thereof may be optionally defined depending on particular use, storage stability, low-temperature curing property and the physical properties of the cured product, and so on.

Further, in the present invention, the compound (B) in which at least one epoxy group, and at least one blocked isocyanate group are included in each of molecules thereof; the compound (A) having two or more blocked isocyanate groups; and the compound (c) having two or more epoxy groups can be further mixed together and used. In this case, a mixing ratio thereof may be optionally defined according to the application and physical properties of the cured product.

The content of the compound (c) having two or more epoxy groups to be included in the curable resin composition of the present invention is from 1 to 95 parts by weight, preferably from 1 to 70 parts by weight, more preferably 2 to 40 parts by weight, most preferably from 5 to 20 parts by weight with respect to 100 parts by weight of the mixture of the compounds (A) and (c) (if the compound (a) is included, the mixture is comprised of the compound (A) including the compound (a) and the compounds (a) and (c)). In this range, excellent weatherability of the composition can be obtained by the mixture of the epoxy compounds while keeping excellent storage stability and low-temperature curing property of the composition in spite of mixing the epoxy compounds.

In addition, the term “the content of the compound (c) having two ore more epoxy groups” is applied on the composition that contains the compound (A) having the blocked isocyanate group but not epoxy group, and is not applied on the composition that contains the compound (B) having at least one epoxy group and at least one free isocyanate group in its molecule.

The composition in accordance with the second aspect of the present invention is allowed to use at least one of the nylon salts (I), (II), and (III). If these nylon salts are used, it becomes possible to combine excellent storage stability and low-temperature curing property. The nylon salts (I), (II), or (III) may be used solely or used as a mixture of one or more nylon salts, and also all of them may be mixed together. In this case, a mixing ratio thereof may be optionally defined depending on particular use, storage stability, low-temperature curing property and the physical properties of the cured product, and so on.

The content of the nylon salt (I) in the curable resin composition of the second aspect of the present invention is from 2 to 60 parts by weight, preferably from 5 to 50 parts by weight, more preferably from 10 to 30 parts by weight with respect to 100 parts by weight of the mixture of the compound (c) and the compound (A) or compound (B) having at least one epoxy group and at least one blocked isocyanate group in each molecules thereof (if the compound (a) is included, the mixture is comprised of the compound (A) including the compound (a) and the compounds (a) and (c)).

The content of the nylon salt (II) is from 2 to 60 parts by weight, preferably from 5 to 50 parts by weight, more preferably from 10 to 30 parts by weight with respect to 100 parts by weight of the mixture of the compound (c) and the compound (A) or compound (B) having at least one epoxy group, and at least one blocked isocyanate group, in each molecules thereof (if the compound (a) is included, the mixture is comprised of the compound (A) including the compound (a) and the compounds (a) and (c)).

The content of the nylon salt (III) is from 2 to 60 parts by weight, preferably from 5 to 50 parts by weight, more preferably from 10 to 30 parts by weight with respect to 100 parts by weight of the mixture of the compound (c) and the compound (A) or compound (B) having at least one epoxy group, and at least one blocked isocyanate group, in each molecules thereof (if the compound (a) is included, the mixture is comprised of the compound (A) including the compound (a) and the compounds (a) and (c)).

Within this range, excellent storage stability and low-temperature curing property can be compatible with each other.

The curable resin composition of the second aspect of the present invention may include one polymer or a mixture of two or more polymers except the compounds of the present invention within the range that does not impair the object of the present invention. If required, the above composition may further include at least one of a plasticizer, a filler, a catalyst, a solvent, a UV absorbent, a dye, a pigment, a fire retardant, a reinforcing agent, an antiaging agent, an antioxidant, a thixotropy imparting agent, a surfactant (including leveling agent), a dispersing agent, a dehydrating agent, a rust-preventive agent, an adhesion providing agent, an antistatic agent, and so on. The polymers except the compounds used in the present invention, the plasticizer, the filler, the catalyst, the solvent, the UV absorbent, the dye, the pigment, the fire retardant, the reinforcing agent, an antiaging agent, an antioxidant, a thixotropy imparting agent, the surfactant (including leveling agent), the dispersing agent, the dehydrating agent, the rust-preventive agent, the adhesion providing agent, the antistatic agent, and so on to be used may be all of those described above, respectively.

As an example of the process for manufacturing the curable resin composition of the second aspect will be now described. In the process, at first, the prepolymer having two or more epoxy groups and the prepolymer having two or more blocked isocyanate groups are placed in a kneader in which nitrogen gas is charged. If required, one or more additional component such as a plasticizer and a filler may be also placed in the kneader. After that, nylon salt is added in the kneader, followed by sufficiently mixing the mixture at low temperature (from room temperature to 40° C.) under reduced pressure. The resulting composition may be used as it is, or may be sealed and cooled after being filled in a container to store the composition.

Examples of the application of the curable resin composition of the second aspect include coating compositions, adhesive agents, sealing agents, other molded products, and so on. In particular, as the curable resin composition includes epoxy component, it has low-temperature curing property with durability and heat-resistance, and therefore can be appropriately used as an adhesive agent for attaching interior decoration products such as plastic parts on a steel plate in the vehicle production.

According to the second aspect of the present invention, the curable resin composition is designed such that the nylon salt as a thermal-latent curing agent is contained not only in the compound having the blocked isocyanate group, but also in the compound having the blocked isocyanate group and the epoxy group, or the mixture of the compound having the blocked isocyanate group and the compound having the epoxy group. Thus, the composition of the second aspect is allowed to combine excellent low-temperature curing property and storage stability and exerts an excellent weatherability.

A third aspect of the present invention is a curing resin composition that includes a compound (a) having two or more isocyanate groups; a compound (d) having two or more vinyl (thio) ether groups; and at least one selected from the above nylon salts (I), (II), and (III).

The compound (a) having two or more isocyanate groups may be one selected from all of the isocyanate compounds (a) described above. Here, a part of the isocyanate groups in the compound (a) may be blocked with the blocking agent described above.

In this invention, the term “vinyl (thio) ether group” means a vinyl ether group, a vinyl thioether group, or a combination thereof. That is, “the compound (d) having two or more vinyl (thio) ether groups” is a compound having two or more vinyl ether groups, a compound having two or more vinyl thioether groups, or a compound having two or more vinyl ether groups and vinyl thioether groups in total.

The term “compound (d) having two or more vinyl (thio) ether groups” means a compound having two or more functional groups represented by the following general formula (5) in one molecule thereof.

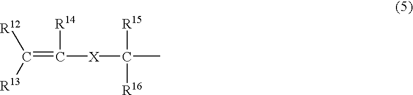

(where R¹² to R¹⁶ independently represent a hydrogen atom or an organic group having 1 to 18 carbon atoms; R¹² or R¹³ and R¹⁵ or R¹⁶ may be linked with each other to form a heterocyclic ring that contains X; and R¹⁵ or R¹⁶ may be linked with each other to form a ring together with their linked carbon atoms without containing X, and X represents an oxygen atom or a sulfur atom).

Here, the organic group may be an alkyl group, a cycloalkyl group, an aryl group, an alkylene group, a cycloalkylene group, or an allylene group, which may be substituted or not with at least one atomic group, selected from a group, consisting of a cycloalkyl group, an alkoxyl group, a cycloalkoxyl group, an aryl group, an aryloxyl group, an alkanoiloxy group, an aralkyloxy group, and a halogen atom.

Examples of the functional group represented by the general formula (5) is not particularly limited and may include vinyl ether groups such as a methylvinyl ether group, an ethylvinyl ether group, an isopropylvinyl ether group, an n-propylvinylether group, an n-butylvinylether group, an isobutylvinyl ether group, a 2-ethylhexyl vinylether group, and a cyclohexyl vinylether group, and vinyl thioether groups corresponding to the respective vinylether groups; and cyclic vinylether group, linked at the 2-position, such as a 2,3-dihydrofuranyl group, a 3,4-dihydro-2H-piranyl group, a 3,4-dihydro-2-methoxy-2H-piranyl group, a 3,4-dihydro-2-ethoxy-2H-piranyl group, a 2,3-dihydrobenzopiranyl group, and a 2,3-dihydrobenzofuranyl group, and cyclic vinylthioether groups corresponding to the respective cyclic vinylether groups, and so on.

In the above general formula (5), preferably, R¹² to R¹⁴ independently represent a hydrogen atom or an alkyl group having 1 to 18 carbon atoms. Preferably, furthermore, R¹⁵ or R¹⁶ independently represent a hydrogen atom or an alkyl or alkylene group having 1 to 18 carbon atoms (R¹² or R¹³ and R¹⁵ or R¹⁶ may be linked with each other to form a heterocyclic ring that contains X, and R¹⁵ or R¹⁶ may be linked with each other to form a ring together with their linked carbon atoms without containing X).

In particular, because of the improvement in reactivity and of facilitating the availability of raw materials, it is preferable that R¹² to R¹⁴ independently represent a hydrogen atom, one of R¹⁵ or R¹⁶ represents a hydrogen atom and the other thereof represents a hydrogen atom or a methyl group, an ethyl group, or a part of a cyclohexane ring which forms a cyclohexane ring together with carbons to which these groups can be linked.

If two or more functional groups are included in one molecule, these functional groups participate in crosslinking reaction to enhance the physical property of the cured product. If a high-molecular vinyl ether compound or the like (including prepolymer) to be described below is used, the number of the functional groups can be optionally defined depending on the use, the physical property of the required cured product, and so on.

The compound (d) having two or more functional groups described above is not particularly limited and may be a low molecular weight compound (monomer) or a high-molecular compound (including prepolymer). Specifically, examples of the compound (d) include the following compounds (d-1), (d-2), and (d-3).

(d-1): Vinyl thioether in which a part or all of oxygen atoms in a low molecular weight polyhydric vinyl ether and a vinyl ether group thereof is substituted with a sulfur atom, where the vinyl thioether include ethylene glycol divinyl ether, diethylene glycol divinyl ether, triethylene glycol divinyl ether, tetraethylene glycol divinyl ether, propylene glycol divinyl ether, butanediol divinyl ether, butanediol diisopropenyl ether, pentanediol divinyl ether, hexanediol divinyl ether, neopentyl glycol diisopropenyl ether, nonane diol divinyl ether, trimethylol propanetrivinyl ether, pentaerythritol trivinyl ether, pentaerythritol tetravinyl ether, 2,2-bis[p-(2-vinyloxyethoxy)phenyl] propane, cyclohexanediol divinyl ether, cyclohexanone dimethanol divinyl ether, acrolein dimer of Chisichienko ester, and so on.

(d-2): Vinyl ether and/or vinyl thioether compound obtained by reacting the polyhydric vinyl ether or vinyl thioether described in the above (d-1) with polyols in the presence of an excess amount of a vinylether group or the like.

Here, polyols include: ethanediol, propanediol, butanediol, pentanediol, octanediol, or homologues thereof, and the corresponding oligomer ethers;

glycerin, trimethylol ethane, trimethylol propane, hexanetriol, pentaerythritol, dipenta erythritol, sorbitol, polyvinyl alcohol, bisphenol-A, resorcin, hydroquinone or derivatives thereof;

tris-hydroxyethyl isocyanurate; hydroxyl group-containing epoxide; hydroxyl group-containing polyether: hydroxyl group-containing polyester; hydroxyl group-containing polyacryl; and so on.

(d-3): Adduct between hydroxyl group-containing monovinyl ether and/or monovinyl thioether and a polyhydric isocyanate compound, for example, adducts between ethylene glycol monovinyl ether, propylene glycol monovinyl ether, 1,4-butylene glycol monovinyl ether, methanol dihydropyrane, hydroxyethylvinyl ether, hydroxybutylvinyl ether, 9-hydroxynonylvinyl ether, 4-hydroxycyclohexyl vinyl ether, cyclohexanone dimethanol monovinyl ether, triethylene glycol monovinyl ether, and so on, and vinyl thioether compounds corresponding to these compounds; tetramethylene diisocyanate, hexamethylene diisocyanate, 2,2,4-trimethylhexamethylene diisocyanate, 1,12-dodecane diisocyanate, cyclohexane-1,3- or 1,4-diisocyanate, isophorone diisocyanate, per-hydro-2,4′- or -4,4′-diphenylmethane diisocyanate, 1,3- and 1,4-phenylene diisocyanate, 2,4- and 2,6-tolylene diisocyanate, diphenylmethane 2,4′- and -4,4′-diisocyanate, 3,2- and 3,4-diisocyanate-4′-methyldiphenylmethane, naphthalene 1,5-diisocyanate, xylylene diisocyanate, tetramethylxylylene diisocyanate, norbornane diisocyanate, triphenyl methane-4,41,4″-triisocyanate, or low molecular weight polyhydric isocyanates thereof, or isocyanurate, burette, or polyol-addition type polyisocyanate, and high molecular polyhydric isocyanate compound (including prepolymer).

Here, the high molecular polyhydric isocyanate compound (including prepolymer) may be an urethane prepolymer or the like, prepared from tolylene diisocyanate, hexamethylene diisocyanate, diphenylmethane diisocyanate, xylylene diisocyanate, tetramethylxylylene diisocyanate, and polypropylene glycol, polytetramethylene etherglycol, and polyester polyol.

Among these compounds (d), particularly, in terms of cost reduction, the low molecular weight polyhydric vinyl ether and its corresponding low molecular weight polyhydric vinyl thioether may be preferably used. In addition, in terms of facilitating the control of the physical property of the adduct between a polyhydric isocyanate compound and a hydroxyl group-containing monovinyl ether and/or monovinyl thioether may be preferably used.

If the above high molecular compound or the like is used as the compound (d), the molecular weight of the main chain thereof is not particularly limited. It can be optionally defined by the property, use, or the like of the composition.

In addition, the compound (d) having two or more vinyl (thio) ether groups can be used solely or used as a mixture of two or more compounds. In this case, a mixing ratio thereof may be optionally defined depending on the physical properties to be required by the cured product, particular use thereof, and so on.

The mixture of the compound (a) having two or more free isocyanate groups and the compound (d) having two or more vinyl (thio) ether groups may be one prepared by mixing at least one of the compounds (a-1), (a-2), and (a-3), which include two or more active isocyanate groups with at least one of the vinyl (thio) ether compounds (monomer) (d-1), (d-2), and (d-3). In this case, a mixing ratio thereof may be optionally defined depending on particular use, storage stability, low-temperature curing property and the physical properties of the cured product, and so on.

The content of the compound (d) having two or more vinyl (thio) ether groups to be included in the curable resin composition of the third aspect is from 1 to 50 parts by weight, preferably from 2 to 30 parts by weight, more preferably from 3 to 10 parts by weight with respect to 100 parts by weight of the compound (a) having two isocyanate groups. Within this range, excellent storage stability of the curable resin composition can be compatible with its excellent low-temperature curing property.

In the composition of the third aspect of the present invention, there may be used at least one of the above-mentioned nylon salts (I), (II), and (III) as the thermal latent curing agent. If these nylon salts are used, it becomes possible to combine excellent storage stability and low-temperature curing property.

The nylon salts (I), (II), or (III) may be used solely or used as a mixture of one or more nylon salts, and also all of them may be mixed together. In this case, a mixing ratio thereof may be optionally defined depending on the particular use, storage stability, low-temperature curing property and the physical properties of the cured product, and so on.

The content of the nylon salt (I) in the curable resin composition in accordance with the third aspect of the present invention is from 2 to 60 parts by weight, preferably from 5 to 50 parts by weight, more preferably from 10 to 30 parts by weight with respect to 100 parts by weight of the mixture of the compound (a) and the compound (d).

The content of the nylon salt (II) is from 2 to 60 parts by weight, preferably from 5 to 50 parts by weight, more preferably from 5 to 30 parts by weight with respect to 100 parts by weight of the mixture of the compound (a) and the compound (d).

The content of the nylon salt (III) is from 2 to 60 parts by weight, preferably from 5 to 50 parts by weight, more preferably from 10 to 30 parts by weight with respect to 100 parts by weight of the mixture of the compound (a) and the compound (d).

Within this range, excellent storage stability of the curable resin composition can be compatible with its excellent low-temperature curing property.

The composition in accordance with the third aspect of the present invention may comprise one polymer or a mixture of two or more polymers apart from the compounds of the present invention within the range that does not impair the object of the present invention. If required, the above composition may further include at least one of a plasticizer, a filler, a catalyst, a solvent, a UV absorbent, a dye, a pigment, a fire retardant, a reinforcing agent, an antiaging agent, an antioxidant, a thixotropy imparting agent, a surfactant (including leveling agent), a dispersing agent, a dehydrating agent, a rust-preventive agent, an adhesion providing agent, an antistatic agent, and so on. The polymers, the plasticizer, the filler, the catalyst, the solvent, the UV absorbent, the dye, the pigment, the fire retardant, the reinforcing agent, the antiaging agent, the antioxidant, the thixotropy imparting agent, the surfactantant (including leveling agent), the dispersing agent, the dehydrating agent, the rust-preventive agent, the adhesion providing agent, the antistatic agent, and so on other than those compounds used in the present invention may be all of those described above, respectively.

An example of the process for manufacturing the curable resin composition of the third aspect is described below. In the process, at first, the prepolymer having two or more isocyanate groups and the prepolymer having two or more vinyl ether groups are placed in a kneader into which nitrogen gas is charged. If required, one or more additional components such as a plasticizer and a filler may be also placed in the kneader. After that, nylon salt is added in the kneader, followed by sufficiently kneading the mixture at low temperature (from room temperature to 40° C.) under reduced pressure. The resulting composition may be used as it is, or may be sealed and cooled after filling in a container to store the composition.

Examples of the application of the curable resin composition of the third aspect include coating compositions, adhesive agents, sealing agents, other molded products, and so on. In particular, as the curable resin composition has low-temperature curing property, it can be appropriately used as an adhesive composition for attaching interior decoration such as plastic parts on a steel plate in a vehicle production.

If the compound having the vinyl (thio) ether group is used, such a compound also participates in three-dimensional crosslinking reaction and the physical property of the cured product can be increased. In particular, dicarboxylic acid generated by the thermal dissociation of nylon salt is generally less reactive to an isocyanate group, compared with diamine. If a part thereof remains, it can be allowed to participate in crosslinking reaction as it reacts with the compound having a vinyl (thio) ether group. Therefore, it is considered that the physical property of the cured product can be increased as the remaining amount of the dicarboxylic acid released in the composition after the curing decreases.

Furthermore, as the compound having the vinyl (thio) ether group and the nylon salt are included as thermal-latent curing agents in the curable resin compound, the vinyl (thio) ether group compensates the decrease in the amount of nylon salt which can be thermally dissociated into diamine and dicarboxylic acid during the storage. Therefore, it can be used as a base resin as it is even if the isocyanate group is not blocked. Therefore, the composition combines excellent low-temperature curing property and excellent storage stability, allowing good workability and cost reduction.

The fourth aspect of the present invention is a curable resin composition including: a compound (e) having at least one isocyanate group, at least one vinyl (thio) ether group, and at least one epoxy group in its respective molecules, or a compound (a) having two or more isocyanate groups; and a mixture of a compound (d) having two or more vinyl (thio) ether group and a compound (c) having two or more epoxy groups; and at least one selected from a group consisting of the nylon salts (I), (II), and (III).

The compound (e) having at least one isocyanate group, at least one vinyl (thio) ether group, and at least one epoxy group in its respective molecules may be a compound (monomer, (e-1)) having these groups in its molecule, and/or prepolymer (e-2) having these groups in its molecule.

The compound or prepolymer having these three functional groups in its molecule can participate in crosslinking reaction in the molecule and/or between the molecules, resulting in a cured composition.

The compound (monomer, (e-1)) having at least one isocyanate group, at least one vinyl (thio) ether group and at least one epoxy group in its respective molecules may be, for example, a reactant between a polyisocyanate compound, a hydroxyl group-containing vinyl (thio) ether compound and a hydroxyl group-containing epoxy compound.

The polyisocyanate compound may be one selected from any of the compounds described above in (a-1), the hydroxyl group-containing vinyl (thio) ether compound may be one selected from any of the compounds described above in examples of the compound (d) and the hydroxyl group-containing epoxy compound may be one selected from any of those compounds described above. The reaction conditions may be those typically used for the production of urethane prepolymer.

The prepolymer (e-2) having three functional groups in its molecule can be obtained in production of urethane polymer by using an isocyanate compound (a), an epoxypolyol (hydroxyl group containing epoxy compound) and a compound (d-2) having the vinyl (thio) ether group (an excess amount of hydroxyl group is reacted with the isocyanate group) or (d-3). A prepolymer having one of the above-mentioned functional groups can be grafted with a side chain that contains the rest of the functional groups to provide a prepolymer (e-2), or prepolymers having their respective functional groups can be copolymerized.

The epoxypolyol may be one selected from any of those described in the second aspect. Likewise, the compounds (d-2), (d-3) having the vinyl (thio) ether groups and the hydroxyl group-containing epoxy compound, and their manufacturing processes are also selected from those described above.

Furthermore, the isocyanate compounds of the present invention may be any of the polyisocyanate compounds (a) described above. In the present invention, however, there is no need to block the isocyanate group in the compound. As the vinyl (thio) ether group is included in its molecule, extremely excellent storage stability can be compatible with low-temperature curing property even though the isocyanate group is not blocked.

The molecular weight of the prepolymer (e-2) to be used is preferably equal to a number average molecular weight of 400 to 10000, more preferably 2000 to 7000 quantified by gel permeation chromatography (GPC) because there is no increase in the viscosity of the prepolymer while the physical properties of the cured product is excellent.

In addition, the prepolymer may be used solely or two or more prepolymers may be used as a combination thereof. In this case, a mixing ratio thereof may be optionally defined depending on particular use, storage stability, low-temperature curing property and the physical properties of the cured product, and so on.

The conditions of manufacturing the prepolymer are not particularly limited, and those generally used for the process of manufacturing urethane prepolymer in the art can be included. For instance, a desired reaction can be performed at a temperature of approximately from 50 to 100° C. under atmospheric pressure. Further, an urethane catalyst such as an organic tin compound or an organic bismuth compound may also be used.

There is no particular imitation on the prepolymer having one of those functional groups described above with a grafted side chain having the rest of them to provide a prepolymer (e-2). Alternatively, there is no particular limitation on the prepolymers which are subjected to a copolymerization to obtain a copolymerized prepolymer. Their manufacturing conditions may also be those generally used in the art. For instance, there is a process in which an urethane prepolymer may be synthesized under the conditions described above, followed by partially adding a vinyl (thio) ether compound having epoxypolyol and hydroxyl group on an isocyanate group in the terminal ends of the prepolymer.

The compound (e) having at least one of three functional groups described above in its respective molecules can be used by mixing one or more compounds (monomer, (e-1)) having these functional groups respectively included in its molecule with one or more prepolymer (e-2) having these functional groups in the respective molecules. In this case, a mixing ratio thereof may be optionally defined depending on particular use, storage stability, low-temperature curing property and the physical properties of the cured product, and so on.

As the mixture of the above-mentioned compound (a) having two or more isocyanate groups and the compound (d) having two or more vinyl (thio) ether groups and the compound (c) having two, or more epoxy groups all the aforementioned compounds (a), (c) and (d) may be used and in addition a mixture of one or two or more of each compound may also be used. In this case, a mixing ratio thereof may be optionally defined depending on the particular use, storage stability, low-temperature curing property and the physical properties of the cured product, and so on.

In the present invention, the compound (e) having at least one of the aforementioned three functional groups in each molecule thereof and a mixture of the aforementioned compounds (a), (c) and (d) can be mixed together and used. In this case, a mixing ratio thereof may also be optionally defined according to its use and physical properties of the cured product.

The respective contents of the compound (a), (c) and (d) to be included in the curable resin composition of the present invention is: from 30 to 97.5 parts by weight, preferably from 60 to 96 parts by weight, most preferably from 75 to 94.5 parts by weight for the compound (a); from 2 to 50 parts by weight, preferably 3 to 30 parts by weight, most preferably 4 to 20 parts by weight for the compound (c); and from 0.5 to 20 parts by weight, preferably 1 to 10 parts by weight, most preferably 1.5 to 5 parts by weight for the compound (d), with respect to 100 parts by weight of the mixture of the compounds (a), (c) and (d). Within this range, an excellent weatherability of the composition can be obtained by mixing the epoxy compounds while keeping excellent storage stability and low-temperature curing property of the composition in spite of mixing the epoxy compounds therein.

In the composition in accordance with the fourth aspect of the present invention, at least one of the aforementioned nylon salts (I), (II) and (III) can be used as a thermal-latent curing agent. If these nylon salts are used, it becomes possible to combine excellent storage stability and low-temperature curing property. The nylon salts (I), (II) or (III) may be used solely or used as a mixture of one or two or more nylon salts, and also all of them may be mixed together. In this case, a mixing ratio thereof may be optionally defined depending on the particular use, storage stability, low-temperature curing property and the physical properties of the cured product, and so on.

The content of the nylon salt (I) in the curable resin composition of the fourth aspect in accordance with the present invention is from 2 to 60 parts by weight, preferably from 5 to 50 parts by weight, more preferably from 10 to 30 parts by weight with respect to 100 parts by weight of the compound (e) having at least one of the aforementioned three functional groups in each molecule thereof or the mixture of the compound (a), (c) and (d).

The content of the nylon salt (II) is from 2 to 60 parts by weight, preferably from 5 to 50 parts by weight, more preferably from 10 to 30 parts by weight with respect to 100 parts by weight of the compound (e) having at least one of the aforementioned three functional groups in each molecule thereof or the mixture of the compound (a), (c) and (d).

The content of the nylon salt (III) is from 2 to 60 parts by weight, preferably from 5 to 50 parts by weight, more preferably from 5 to 30 parts by weight with respect to 100 parts by weight of the mixture of the compound (e) having at least one of the above-mentioned three functional groups in each molecule thereof and the mixture of the compounds (a), (c) and (d).

Within this range, extremely excellent storage stability and low-temperature curing property can be compatible with each other.

The curable resin composition in accordance to the fourth aspect of the present invention may include one polymer or a mixture of one or more polymers other than the compounds of the present invention within the range that does not impair the object of the present invention. If required, the above composition may further include at least one of a plasticizer, a filler, a catalyst, a solvent, a UV absorbent, a dye, a pigment, a fire retardant, a reinforcing agent, an antiaging agent, an antioxidant, a thixotropy imparting agent, a surfactant (including leveling agent), a dispersing agent, a dehydrating agent, a rust-preventive agent, an adhesion providing agent, an antistatic agent, and so on. The polymers, the plasticizer, the filler, the catalyst, the solvent, the UV absorbent, the dye, the pigment, the fire retardant, the reinforcing agent, the antiaging agent, the antioxidant, the thixotropy imparting agent, the surfactantant (including leveling agent), the dispersing agent, the dehydrating agent, the rust-preventive agent, the adhesion providing agent, the antistatic agent, and so on other than the compounds used in the present invention may be all of those described in above, respectively.

An example of the process for manufacturing the curable resin composition of the fourth aspect is described below. In the process, at first, compounds (a), (c) and (d) are placed in a kneader into which nitrogen gas is charged. Further, if required, additional components such as a plasticizer and a filler may also be placed in the kneader. After that, nylon salt is added in the kneader, followed by sufficiently kneading the mixture at low temperature (from room temperature to 40° C.) under reduced pressure. The resulting composition may be used as it is, or may be sealed and cooled after filling in a container to store the composition.

Examples of the application of the curable resin composition of the fourth aspect include coating compositions, adhesive agents, sealing agents, other molded products, and so on. In particular, as the curable resin composition contains epoxy components, it can be appropriately used as a composition having low-temperature curing property, durability and heat resistance as well as an adhesive composition for attaching interior decoration such as plastic parts on a steel plate in the vehicle production.

If the compound having the vinyl (thio) ether group is used, such a compound also participates in three-dimensional crosslinking reaction and the physical property of the cured product can be increased. In particular, dicarboxylic acid generated by the thermal dissociation of nylon salt is generally less reactive to an isocyanate group compared with diamine. If a part thereof is remained, it can be allowed to participate in crosslinking reaction as it reacts with the compound having a vinyl (thio) ether group. Therefore, it is considered that the physical property of the cured product can be increased as the remaining amount of the dicarboxylic acid released in the composition after the curing decreases.

Furthermore, as the compound having the vinyl (thio) ether group and the nylon salt are included as thermal-latent curing agents in the curable resin compound, the vinyl (thio) ether group can scavenge the diamine and dicarboxylic acid, generated by the thermally dissociation of the nylon salt and therefore, the composition combines excellent low-temperature curing property and excellent storage stability even if the isocyanate group is not blocked.

As described above, use of the compound having the vinyl (thio) ether group leads to an improvement in physical properties of the cured compound. In addition, use of this compound leads to an improvement in storage stability while retaining the low temperature curing property of the composition even if the isocyanate group is not blocked. Furthermore, such a compound does not influence the improvement in weatherability by the compound having the epoxy resin. In other words, if the nylon salt is included as a thermal-latent curing agent in a mixture of the compound having a free isocyanate group, a vinyl (thio) ether group and an epoxy group included in its molecule or the compound having a free isocyanate group, the compound having a vinyl (thio) ether group and the compound having the epoxy group, the resulting composition has excellent low-temperature curing property compatible with excellent storage stability in addition to exert an excellent weatherability.

The fifth aspect of the present invention is a curable resin composition that includes a compound (a) having two or more free isocyanate groups and at least one selected from the group consisting of the aforementioned nylon salts (I) and (III).

The compound (a) having two or more free isocyanate groups must be the one having two or more free isocyanate groups (at the respective terminal ends). In the presence of two or more isocyanate groups in the compound, a crosslinking reaction is allowed to proceed in the molecule and/or between the molecules. As a result, the cross-linking density can be sufficiently increased and excellent physical property of the cured product can also be attained.

The compound (a) having two or more free isocyanate groups comprises:

(a-1) a polyisocyanate compound;

(a-2) a mixture of a polyisocyanate compound and a polyol compound (monomer); and

(a-3) an urethane polymer having a free isocyanate group on its terminal end, obtained by reacting a polyol compound (polymer) having an hydroxyl group on a terminal end thereof with an excess amount of a polyisocyanate compound with respect to the hydroxyl group.

The compound (a) having two or more of these free isocyanate groups is the same as that described in each of the first and third aspects of the present invention, and all of the exemplified compounds (a) in these aspects can be used in the present aspect.

Also, the nylon salts (I) and (III) used in the fifth aspect of the present invention are the same as those described in the first aspect of the present invention, and each of the exemplified nylon salts in the first aspect can be used in the present aspect.

The nylon salt (I) is used solely or used as a mixture of two or more nylon salts. The nylon salt (III) is also used in a like manner. In addition, the nylon salts (I) and (III) may be used as a mixture thereof. In this case, a mixing ratio thereof may be optionally defined depending on the particular use, storage stability, low-temperature curing property and the physical properties of the cured product, and so on.

The process for manufacturing the aforementioned nylon salt is not limited to a specific one. For instance, the process may include the steps of: mixing diamine with carboxylic acid in water or alcohol such as methanol at equivalent ratio of (the equivalent of carboxyl group of the carboxylic acid)/(per one equivalent amino group of the diamine)=1.00 to 1.05) and standing or cooling the mixture solution under predetermined conditions to precipitate nylon salt out of the mixture solution.

The resulting nylon salt is water-soluble and is also very stable at room temperature. In addition, the nylon salt cannot be dissociated or dissolved by absorbing moisture from the air.

The content of the nylon salt (I) in the curable resin composition in accordance with the fifth aspect of the present invention is from 2 to 60 parts by weight, preferably from 5 to 50 parts by weight, more preferably from 10 to 30 parts by weight with respect to 100 parts by weight of the compound having two or more isocyanate groups.

The content of the nylon salt (III) is from 2 to 60 parts by weight, preferably from 5 to 50 parts by weight, more preferably from 5 to 30 parts by weight with respect to 100 parts by weight of the mixture of the compound having two or more isocyanate groups.

Within this range, extremely excellent storage stability and low-temperature curing property can be compatible with each other.

In the curable resin composition of the fifth aspect of the present invention, one polymer or a mixture of two or more polymers except the compounds of the present invention can be included within the range that does not impair the object of the present invention. If required, the above composition may further include a plasticizer, a filler, a catalyst, a solvent, a UV absorbent, a dye, a pigment, a fire retardant, a reinforcing agent, an antiaging agent, an antioxidant, a thixotropy imparting agent, a surfactant (including leveling agent), a dispersing agent, a dehydrating agent, a rust-preventive agent, an adhesion providing agent, an antistatic agent, and so on. The polymers except the compounds used in the present invention, the plasticizer, the filler, the catalyst, the solvent, the UV absorbent, the dye, the pigment, the fire retardant, the reinforcing agent, an antiaging agent, an antioxidant, a thixotropy imparting agent, the surfactantant (including leveling agent), the dispersing agent, the dehydrating agent, the rust-preventive agent, the adhesion providing agent, the antistatic agent, and so on may employ all of those described in the above, respectively.

The details of the aforementioned additional agents or compounds are already described in the first aspect of the present invention and are omitted in the following description. Regarding the content thereof which can be included in the desired composition, the description of the first aspect defines it with respect to 100 parts by weight of the compound (A) having two or more blocked isocyanate groups. In the fifth aspect and also in a sixth aspect described below, such a content of the additional agent will be recognized as one with respect to 100 parts by weight of the compound (a) having two or more free isocyanate groups.

An example of the process for manufacturing the curable resin composition of the fifth aspect is described below. In the process, at first, the compound having two or more free isocyanate groups is placed in a kneader in which nitrogen gas is charged. Further, if required, one or more additional components such as a plasticizer and a filler may be also placed in the kneader. After that, nylon salt is added in the kneader, followed by sufficiently kneading the mixture at low temperature (from room temperature to 40° C.) under reduced pressure. The resulting curable resin composition may be used as it is, or may be sealed and cooled after being filled in a container to store the composition.

Examples of the application of the curable resin composition of the fifth aspect include coating compositions, adhesive agents, sealing agents, other molded products, and so on. In particular, as the curable resin composition has low-temperature curing property, it can be appropriately used as an adhesive composition for attaching interior decoration such as plastic parts on a steel plate in the vehicle production.

The thermosetting resin composition of the fifth aspect is a thermosetting resin composition which can be converted into an urethane polymer. That is, when it is heated at a temperature of approximately 80 to 100° C., the composition releases both diamine and carboxylic acid as the nylon salts (I) and (III) in the composition are thermally dissociated. The nylon salts act as thermal-latent curing agents, and the resulting diamine and carboxylic acid respectively participate in three-dimensional crosslinking reaction with the isocyanate group of the compound having two or more free isocyanate groups and it results in a urethane polymer.

Therefore, the thermal dissociation of the nylon salts (I) and (III) in the composition can occur at low temperature (approximately 80 to 100° C.), and the three-dimensional crosslinking reaction proceeds around such a temperature, so that the composition can exert excellent low-temperature curing property.

Furthermore, the curing agent well known in the art which can be thermally dissociated at low temperature shows poor storage stability as a three-dimensional crosslinking reaction gradually proceeds before reaching a thermally curing temperature. In the nylon salt of the present invention, on the other hand, the thermal dissociation thereof hardly occurs at a temperature less than the thermal dissociation temperature and the three-dimensional crosslinking reaction is not initiated, so that excellent storage stability can be obtained. In other words, no thermal crosslinking agent is generated, so that the crosslinking reaction hardly occurs even if the isocyanate group is not blocked. Thus, the compound having the free isocyanate group can be used as a base resin without any modification. Concretely, the composition of the present aspect has excellent storage stability, allowing good workability and cost reduction. Furthermore, there are no undesired additional components such as a blocking agent in the cured product, so that the desired physical property of the cured product can be exerted.

The sixth aspect of the present invention is a curable resin composition comprises: a mixture of a compound (b) having at least one epoxy group and at least one free isocyanate group respectively included in its molecule or a compound (a) having two or more free isocyanate groups, and a compound (c) having two or more epoxy groups; and the above nylon salt (I) or the aforementioned nylon salt (III) in the mixture.

Here, the compound (b) having at least one epoxy group and at least one free isocyanate group respectively included in its molecule is a compound having the aforementioned groups in each molecule thereof (monomer, (b-1)) and/or a prepolymer (b-2) having the aforementioned groups in each molecule thereof.

The mixture of the compound (a) having two or more free isocyanate groups and the compound (c) having two or more epoxy groups are a mixture of the compounds (a-1), (a-2), and/or (a-3) having two or more free isocyanate groups described above and the compound (c) having two or more epoxy groups.

In the sixth aspect, the compound (b) having at least one epoxy group and at least one free isocyanate group respectively included in its molecule participates in crosslinking reaction in the molecule and/or between the molecules in the composition, so that a cured product can be obtained.

The compound (b) may be, for example, a monomer (b-1) provided as a reactant of an epoxy compound having a hydroxyl group and a polyisocyanate compound.

Examples of the polyisocyanate compound may be all of the exemplified polyisocyanate compounds (a-1) described above.

Examples of the epoxy compound having the hydroxyl group include, although not particularly limited thereto, glycidol, glycerol diglycidyl ether, sorbitol polyglycidyl ether, trimethylolpropane diglycidyl ether, polypropylene glycol monoglycidyl ether, polyethylene glycol monoglycidyl ether, glycerol diglycidyl ether, bisphenol-A monoglycidyl ether, bisphenol-S monoglycidyl ether, diglycidyl amino phenol, (2S,3S)-3-phenyl glycidol, and so on.

Of those, glycidol and glycerol diglycidyl ether are preferable because each of them has a high reactivity to the isocyanate compound at a low viscosity which is enough to easily obtain the monomer (b-1).

For obtaining the monomer (b-1) by the reaction between the aforementioned polyisocyanate compound (a-1) and the epoxy compound having the hydroxyl group, the reaction may be performed using an excess amount of the polyisocyanate compound under the typical conditions.

Furthermore, an example of the compound (b) includes a prepolymer (b-2) having at least one epoxy group and at least one free isocyanate group respectively included in its molecule.

Such a polymer can be obtained in the process for manufacturing an urethane prepolymer using epoxy polyol. In this case, a prepolymer can be obtained by grafting a prepolymer which has one of the aforementioned groups with a side chain having the other of the aforementioned groups. Alternatively, both prepolymer maybe copolymerized.

Examples of the epoxy polyol that may be used specifically include, although not particularly limited thereto, epoxy polyols of bisphenol-A-based, glycidyl ether-based, and so on; epoxy compounds having the aforementioned hydroxyl group; and so on. The manufacturing process thereof is also not limited to a specific one. In particular, the process may include the step of reacting the epoxy resin of bisphenol-A-based, glycidyl ether-based, or the like, having epoxy groups on its opposite terminal ends with monoethanol amine, diethanol amine, or the like under the reaction conditions generally used in the art.

The isocyanate compound to be reacted with the epoxy polyol may be selected from all of the polyisocyanate compounds (a-1) described above.

With regard to the molecular weight of the prepolymer (b-2) having at least one epoxy group and at least one free isocyanate group in each molecule thereof, a prepolymer with a number average molecular weight of 400 to 1000 quantified by gel permeation chromatography, (GPC), more preferably of 2000 to 7000, is preferred because there is no increase in the viscosity of the prepolymer and the physical properties of the cured product is excellent.

Furthermore, the prepolymer may used solely or used as a mixture of two or more prepolymers. In this case, a mixing ratio thereof may be optionally defined depending on the particular use, storage stability, low-temperature curing property and the physical properties of the cured product, and so on.

The conditions for manufacturing the prepolymer is not particularly limited and may be those used for the conventional urethane prepolymer. That is, the reaction can be performed at a temperature of approximately 50 to 100° C. under atmospheric pressure. Furthermore, an urethane-forming catalyst such as an organic tin compound and an organic bismuth compound may be used.

The prepolymer obtained by grafting a prepolymer having one of the aforementioned groups with a side chain having the other of the aforementioned groups and the prepolymer obtained by copolymerizing both polymers are not specifically limited. The manufacturing conditions thereof may also be those generally used in the art. For example, there is a process in which an additional reaction between two equivalent weights of bisphenol-A glycidyl ether and less than one equivalent weight of monoethanol amine or diethanol amine is performed to elongate the chain, and a hydroxyl group generated by the additional reaction is then reacted with a polyisocyanate compound.

The compound (b) having at least one epoxy group and at least one free isocyanate group in each molecule can be used by mixing one or more compounds (b-1) having the aforementioned groups in each molecule thereof with one or more prepolymers (b-2) having the aforementioned groups in each molecule thereof. In this case, a mixing ratio thereof may be optionally defined depending on the particular use, storage stability, low-temperature curing property and the physical properties of the cured product, and so on.

The mixture of the compound (a) having two or more free isocyanate groups and the compound (c) having two or more epoxy groups used in the present invention is a mixture of the aforementioned:

(a-1) polyisocyanate compound;

(a-2) mixture of a polyisocyanate compound and a polyol compound (monomer); and

(a-3) urethane prepolymer having a free isocyanate group on its terminal end, obtained by reacting a polyol compound (polymer) having an hydroxyl group on a terminal end thereof with an excess amount of a polyisocyanate compound, and the compound (c) having two or more epoxy groups which will be described below.

For the polyisocyanate compound (a-1); the mixture of a polyisocyanate compound and a polyol compound (monomer) (a-2); and the urethane polymer having a free isocyanate group on its terminal end, obtained by reacting a polyol compound (polymer) having an hydroxyl group on a terminal end thereof with an excess amount of a polyisocyanate compound (a-3), all of the compounds, mixtures and urethane polymers described above can be used.

The compound (c) having two or more epoxy groups is the same as that of the second aspect described above, and all of the exemplified compounds (c) may be used in this aspect and a preferable molecular weight of the compound (c) is also in the same range as that of the second aspect.

The mixture of the compound (a) having two or more free isocyanate group and the compound (c) having two or more epoxy groups may be prepared by mixing one or two or more of the aforementioned compounds (a-1), (a-2), and (a-3) having two or more free isocyanate groups with one or two or more of the epoxy compound (monomer (c-1) and monomer (c-2)). In this case, a mixing ratio thereof may be optionally defined depending on the particular use, storage stability, low-temperature curing property and the physical properties of the cured product, and so on.

In the present invention, the aforementioned compound (b) having at least one epoxy group and at least one free isocyanate group respectively in its molecule; and the aforementioned mixture of the compound (a) having two or more free isocyanate groups and the compound (c) having two or more epoxy groups may be used as a mixture thereof. Also in this case a mixing ratio thereof may be optionally defined depending on the particular use, the physical properties of the cured product, and so on.

The content of the compound (c) having two epoxy groups to be included in the curable resin composition of the sixth aspect is from 1 to 95 parts by weight, preferably from 1 to 70 parts by weight, more preferably from 2 to 40 parts by weight, most preferably from 5 to 20 parts by weight with respect to 100 parts by weight of the mixture of the compounds (a) and (c). Within this range, an excellent weatherablity of the composition can be obtained by the mixture of the epoxy compounds while keeping excellent storage stability and excellent low-temperature curing property of the composition in spite of mixing the epoxy compounds therein.

Here, it is needless to say that the term “the content of the compound (c) having two ore more epoxy groups” is applied as the content ratio to the composition that comprises the compound (a) having the free isocyanate group but not epoxy group, and is not applied as the content ratio to the composition that only comprise the compond (b) having at least one epoxy group and at least one free isocyanate group in its molecule.

For the composition in accordance with the sixth aspect of the present invention, the aforementioned nylon salts (I) and (III) can be used. If these nylon salts are used, it becomes possible to combine excellent storage stability and low-temperature curing property. The nylon salt (I) or (III) may be used by mixing one or two or more, and also both of them may be mixed together. In this case, a mixing ratio thereof may be optionally defined depending on particular use, storage stability, low-temperature curing property and the physical properties of the cured product, and so on.

The content of the nylon salt (I) in the curable resin composition of the present invention is from 2 to 60 parts by weight, preferably from 5 to 50 parts by weight, more preferably from 10 to 30 parts by weight with respect to 100 parts by weight of the compound (b) or the mixture of the compound (a) and the compound (c).

The content of the nylon salt (III) is from 2 to 60 parts by weight, preferably from 5 to 50 parts by weight, more preferably from 5 to 30 parts by weight with respect to 100 parts by weight of the compound (b) or the mixture of the compound (a) and the compound (c).

Within this range, extremely excellent storage stability and low-temperature curing property can be compatible with each other.

The curable resin composition in accordance with the sixth aspect of the present invention can be include one or two or more polymers except the compounds of the present invention within the range that does not impair the object of the present invention. If required, the above composition may further include a plasticizer, a filler, a catalyst, a solvent, a UV absorbent, a dye, a pigment, a fire retardant, a reinforcing agent, an antiaging agent, an antioxidant, a thixotropy imparting agent, a surfactant (including leveling agent), a dispersing agent, a dehydrating agent, a rust-preventive agent, an adhesion providing agent, an antistatic agent, and so on. The polymers except the compounds used in the present invention, the plasticizer, the filler, the catalyst, the solvent, the UV absorbent, the dye, the pigment, the fire retardant, the reinforcing agent, an antiaging agent, an antioxidant, a thixotropy imparting agent, the surfactantant (including leveling agent), the dispersing agent, the dehydrating agent, the rust-preventive agent, the adhesion providing agent, the antistatic agent, and so on may employ all of those described in the above, respectively.

An example of the process for manufacturing the curable resin composition of the present invention is described below. In the process, at first, the prepolymer having an epoxy group and the prepolymer having a free isocyanate group are added in a kneader in which nitrogen gas is charged. If required, one or more additional components such as a plasticizer and a filler may also be added in the kneader. After that, nylon salt is added in the kneader, followed by sufficiently kneading the mixture at low temperature (from room temperature to 40° C.) under reduced pressure. The resulting composition may be used as it is, or may be sealed and cooled after being filled in a container to store the composition.

Examples of the application of the curable resin composition of the sixth aspect include coating compositions, adhesive agents, sealing agents, other molded products, and so on. In particular, since the curable resin composition includes an epoxy component, it can become a composition with low-temperature curing property in addition to durability and heat resistance and is appropriately used as an adhesive composition, for attaching interior decoration such as plastic parts on a steel plate in the vehicle production.

According to the sixth aspect of the present invention, the curable resin composition is designed such that the nylon salt as a thermal-latent curing agent is contained not only in the compound having the free isocyanate group, but also in the compound having the free isocyanate group and the epoxy group, or the mixture of the compound having the free isocyanate group and the compound having the epoxy group. The composition of the sixth aspect can combine excellent low temperature curing property and storage stability and exert an excellent resistance to weatherability.

### EXAMPLES

Hereinafter, the present invention is described in detail by way of examples. However, the present invention should not be limited to the following examples.

1000 g of trifunctional polypropylene glycol (PPG) (made by Asahi Glass Company, Ltd., Exenol 5030, a number average molecular weight of 5000) and 103 g of tolylene diisocyanate ((a mixing ratio between 2,4- and 2,6-tolylene diisocyanate was 80/20), manufactured by Mitsui Chemical, Inc., TDI-80/20)(NCO/OH=2.0) were mixed and reacted while stirring at 70° C. for 17 hours, and it obtained the urethane prepolymer 1 (a number average molecular weight of 5350 (quantified by GPC)).

1000 g of trifunctional PPG (manufactured by Asahi Glass Company, Ltd., Exenol 5030, a number average molecular weight of 5000) and 142 g of meta-tetramethylxylene diisocyanate (TMXDI; manufactured by Mitsui Scitec, Co., Ltd.) (NCO/OH=2.0) were mixed and reacted while stirring at 80° C. for 17 hours, and it obtained the urethane prepolymer 2 (a number average molecular weight of 5500 (quantified by GPC)).

Separately, 15 g of ethylmethyl ketoxime equivalent to 1.5 folds of NCO group was added in the urethane prepolymer 2 and then stirred at 60° C. for 17 hours, and it obtained the blocked prepolymer 2 having a number average molecular weight of 5700.

An epoxy resin used was a bisphenol-A epoxy resin comprised of commercially available bisphenol-A and epichlorohydrin (manufactured by Asahi Denka Kogyo K.K., EP4100E).

A vinylether compound used was a commercially used cyclohexane dimethanol divinyl ether (manufactured by Nippon Carbide Industries Co., Inc., CHDVE).

230 g (1 mol) of dodecane diacid was dissolved in anhydrous isopropyl alcohol by the application of heat, followed by dropping into anhydrous isopropyl alcohol solution of 1,3-xylylene diamine (136 g, 1 mol) at room temperature to mix them together. After mixing, the mixture was stirred at 70° C. and was then cooled down. A white crystallized material was precipitated and then separated through a filtration. The obtained crystallized material was washed using 500 ml of anhydrous isopropyl alcohol, followed by drying (at 760 mmHg, room temperature, for 17 hours). As a result, 350 g of nylon salt A (95% yield) was obtained.

The resulting nylon salt A was crushed and ground in a mortar with a pestle. The nylon salt A thus obtained was used.

230 g (1 mol) of dodecane diacid was dissolved in anhydrous isopropyl alcohol by the application of heat, followed by dropping into an anhydrous isopropyl alcohol solution of piperazine (86 g, 1 mol) at room temperature to mix them together. After mixing, the mixture was stirred at 70° C. and was then cooled down. A white crystallized material was precipitated and then separated through a filtration. The obtained crystallized material was washed using 500 ml of anhydrous isopropyl alcohol, followed by drying (at 760 mmHg, room temperature, for 17 hours). As a result, 300 g of nylon salt B (95% yield) was obtained.

The resulting nylon salt B was crushed and ground in the same manner. The nylon salt B thus obtained was used.

312 g (2 mol) of 4-chloro benzoate was dissolved in anhydrous isopropyl alcohol by the application of heat, followed by dropping into an anhydrous isopropyl alcohol solution of 1,3-xylenediamine (136 g, 1 mol) at room temperature to mix them together. After mixing, the mixture was stirred at 70° C. and was then cooled down. A white crystallized material was precipitated and then separated through a filtration. The obtained crystallized material was washed using 500 ml of anhydrous isopropyl alcohol, followed by drying (at 760 mmHg, room temperature, for 17 hours). As a result, 430 g of nylon salt C (96% yield) was obtained. The resulting nylon salt C was crushed and ground in the same manner. The nylon salt C thus obtained was used.

230 g of dodecane diacid (1 mol) was dissolved in anhydrous isopropyl alcohol by the application of heat, followed by dropping into 112 g of an anhydrous isopropyl alcohol solution of triethylene diamine (1 mol) at room temperature to mix them together. After mixing, the mixture was stirred at 70° C. and was then left to stand to be cooled down. A white crystallized material was precipitated and then separated through a filtration. The obtained crystallized material was washed using 500 ml of anhydrous isopropyl alcohol, followed by drying (at 760 mmHg, room temperature, for 17 hours). As a result, 310 g of nylon salt D (91% yield) was obtained.

The resulting nylon salt D was crushed and ground in the same manner. The nylon salt D thus obtained was used.

230 g (2 mol) of benzoic acid was dissolved in anhydrous isopropyl alcohol by the application of heat, followed by dropping into an anhydrous isopropyl alcohol solution of 1,3-xylenediamine (136 g, 1 mol) at room temperature to mix them together. After mixing, the mixture was stirred at 70° C. and was then left to stand to be cooled down. A white crystallized material was precipitated and then separated through a filtration. The obtained crystallized material was washed using 500 ml of anhydrous isopropyl alcohol, followed by drying (at 760 mmHg, room temperature, for 17 hours). As a result, 340 g of nylon salt E (93% yield) was obtained.

The resulting nylon salt E was crushed and ground in a mortar with a pestle. The nylon salt E thus obtained was used.

304 g (2 mol) of 4-anisic acid was dissolved in anhydrous isopropyl alcohol by the application of heat, followed by dropping into an anhydrous isopropyl alcohol solution of 1,3-xylenediamine (136 g, 1 mol) at room temperature to mix them together. After mixing, the mixture was stirred at 70° C. was then cooled down. A white crystallized material was precipitated and then separated through a filtration. The obtained crystallized material was washed using 500 ml of anhydrous isopropyl alcohol, followed by drying (at 760 mmHg, room temperature, for 17 hours). As a result, 413 g of nylon salt F (94% yield) was obtained.

The resulting nylon salt F was crushed and ground in a mortar with a pestle. The nylon salt F thus obtained was used.

146 g (1 mol) of adipic acid was dissolved in anhydrous isopropyl alcohol by the application of heat, followed by dropping into an anhydrous isopropyl alcohol solution of 1,3-xylenediamine (136 g, 1 mol) at room temperature to mix them together. After mixing, the mixture was stirred at 70° C. was then left to stand to be cooled down. A white crystallized material was precipitated and then separated through a filtration. The obtained crystallized material was washed using 500 ml of anhydrous isopropyl alcohol, followed by drying (at 760 mmHg, room temperature, for 17 hours). As a result, 260 g of nylon salt G (92% yield) was obtained.

The resulting nylon salt G was crushed and ground in the same manner. The nylon salt G thus obtained was used.

The following compositions were prepared and subjected to various examinations.

(Preparation Method)

Components were mixed and stirred at each of the component ratio listed in Table 1 and 2 with a versatile mixing-stirrer (manufactured by Dalton Co., Ltd., 50MV-C1 50 to 100 rpm) under room temperature for 0.5 hour.

Subsequently, 50 g of the composition obtained in each of Examples and Comparative Examples was placed in a metal container at a thickness of 3 mm and was then heated to measure the curing temperature of the composition. That is, the conditions of the cured coating film were observed in increments of 10° C. from 80° C. to 160° C. every 30 minutes.

The obtained results were listed in Table 1 and Table 2, respectively.

The composition obtained in each of Examples and Comparative Examples was filled in the respective airtight containers and was then subjected to nitrogen substitution, followed by allowing the composition to stand for one day at room temperature and 70° C., respectively. Then, the viscosity of each composition was measured using an E-type viscometer. The initial viscosity of the composition measured after standing at the room temperature was compared with the viscosity thereof measured after standing at 70° C. for obtaining the degree of increase in viscosity.

The results were listed in Table 1. If the degree of increase in viscosity is a multiplying factor of 2.0 or less, it is generally considered that the storage stability of the composition is excellent. In Table 1, the term “gelled” means that the composition has gelled as a result of standing at 70° C. and the “cured” means that the composition has cured as a result of standing at 70° C.

TABLE 1

| | Example | | | | | | | | | | Comparative Example | | | | |
|---|---|---|---|---|---|---|---|---|---|---|---|---|---|---|---|
| | 1 | 2 | 3 | 4 | 5 | 6 | 7 | 8 | 9 | 10 | 1 | 2 | 3 | 4 | 5 |
| Urethane prepolymer 1 | 0 | 0 | 0 | 0 | 0 | 100 | 80 | 100 | 80 | 80 | 0 | 0 | 0 | 100 | 80 |
| (parts by weight) | | | | | | | | | | | | | | | |
| Blocked urethane prepolymer | 100 | 80 | 100 | 80 | 80 | 0 | 0 | 0 | 0 | 0 | 100 | 80 | 100 | 0 | 0 |
| 2 (parts by weight) | | | | | | | | | | | | | | | |
| Epoxy resin (parts by weight) | 0 | 20 | 0 | 20 | 20 | 0 | 20 | 0 | 20 | 20 | 0 | 20 | 0 | 0 | 20 |
| Vinyl ether compound (parts | 0 | 0 | 0 | 0 | 0 | 5 | 6 | 5 | 6 | 6 | 0 | 0 | 0 | 5 | 6 |
| by weight) | | | | | | | | | | | | | | | |
| Nylon salt | A | A | B | B | C | A | A | B | B | C | D | D | E | D | D |
| (parts by weight) | 10 | 12 | 9 | 11 | 10 | 10 | 12 | 9 | 11 | 10 | 9 | 11 | 10 | 9 | 11 |
| Curing temperature (° C.) | 100 | 100 | 120 | 120 | 120 | 100 | 100 | 120 | 120 | 120 | 120 | 120 | 120 | 120 | 120 |
| Storage stability (times) | 1.2 | 1.3 | 1.3 | 1.4 | 1.3 | 1.5 | 1.6 | 1.6 | 1.7 | 1.4 | Gelled | Cured | Gelled | Cured | Cured |

TABLE 2

| | Example | | | | | | Comparative Example | | | | |
|---|---|---|---|---|---|---|---|---|---|---|---|
| | 11 | 12 | 13 | 14 | 15 | 16 | 6 | 7 | 8 | 9 | 10 |
| Urethane prepolymer 1 (parts by | 100 | 70 | 0 | 0 | 0 | 0 | 100 | 70 | 100 | 70 | 0 |
| weight) | | | | | | | | | | | |
| Urethane prepolymer 2 (parts by | 0 | 0 | 100 | 80 | 100 | 80 | 0 | 0 | 0 | 0 | 100 |
| weight) | | | | | | | | | | | |
| Epoxy resin (parts by weight) | 0 | 30 | 0 | 20 | 0 | 20 | 0 | 30 | 0 | 30 | 0 |
| Nylon salt | A | A | F | F | C | C | G | G | B | B | E |
| (parts by weight) | 20 | 30 | 5 | 10 | 5 | 10 | 15 | 25 | 15 | 25 | 5 |
| Curing temperature (° C.) | 100 | 100 | 120 | 120 | 120 | 120 | 80 | 100 | 140 | >100 | 120 |
| Storage stability (times) | 1.5 | 1.6 | 1.8 | 1.7 | 1.5 | 1.6 | Cured | Cured | 2.3 | Cured | Cured |

According to the present invention, a curable resin composition comprising a compound having a blocked isocyanate group and a thermal-latent curing agent comprised of a specific nylon salt and having extremely excellent storage stability and excellent low-temperature curing property which can be compatible with each other can be provided. Further the physical or mechanical properties of the curable resin composition are not failed.

Furthermore, according to the present invention, a curable resin composition comprising a compound having an unblocked free isocyanate group, a compound having a vinyl (thio) ether group and a thermal-latent curing agent comprised of a specific nylon salt and having extremely excellent storage stability and excellent low-temperature curing property which can be compatible with each other even if the isocyanate group is not blocked can be provided.

According to the present invention, a curing resin composition having a thermal-latent curing agent only comprises a component which can be directly involved in three-dimensional crosslinking reaction and a compound having a free isocyanate group without being blocked and having extremely excellent storage stability and excellent low-temperature curing property which can be compatible with each other can be provided.

According to the present invention, furthermore, a curable resin composition obtained by additionally including an epoxy compound in each of the above compositions, which has excellent weatherability while keeping storage stability and low-temperature curing property in a balanced manner can be provided.

What is claimed is:

1. A curable resin composition comprising:
a compound having two or more blocked isocyanate groups, wherein an isocyanate group is blocked by a blocking agent and a dissociation temperature between said isocyante group and said blocking agent is 140° C. or less; and
at least one selected from the group consisting of nylon salts (I), (II) and (III), wherein:
the nylon salt (I) comprises a primary diamine represented by the following formula (1) and a dicarboxylic acid represented by the following formula (2):
H₂N—R¹—NH₂ (1)
HOOC—R²—COOH (2)
(where R¹ represents a hydrocarbon group having 8 to 37 carbon atoms, in which a nitrogen atom of an amino group is directly bonded to a carbon atom of aliphatic hydrocarbon; and R² represents a linear hydrocarbon group having 8 to 15 carbon atoms);
the nylon salt (II) comprises a piperazine derivative represented by the following formula (3) and a dicarboxylic acid represented by the following formula (2):
HOOC—R²—COOH (2) 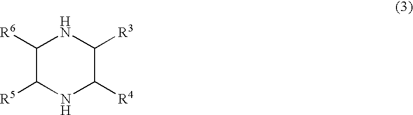
(where R² represents a linear hydrocarbon group having 8 to 15 carbon atoms; and R³ to R⁶ independently represent a hydrogen atom or an alkyl group having 1 to 4 carbon atoms); and
the nylon salt (III) comprises a primary diamine represented by the following formula (1) and a monocarboxylic acid represented by the following formula (4):
H₂N—R¹—NH₂ (1) 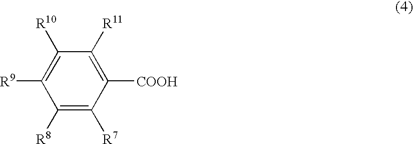
(where R¹ represents a hydrocarbon group having 8 to 37 carbon atoms, in which a nitrogen atom of an amino group is directly bonded to a carbon atom of aliphatic hydrocarbon; R⁷ and R¹¹ independently represent H or OH; R⁸ and R¹⁰ independently represent Cl, Br, I, COOR¹⁷, COR¹⁷, CF₃, CN, SO₂R¹⁷, NO₂ or H; and R⁹ represents Cl, Br, I, COOR¹⁷, COR¹⁷, CF₃, CN, SO₂R¹⁷, H, OH, NR¹⁷₂ or OR¹⁷, and at least one of R⁷ to R¹¹ having said substituent except a hydrogen atom, where R¹⁷ represents a hydrocarbon group having 1 to 5 carbon atoms, and plural of R¹⁷ can be the same or different).

2. A curable resin composition comprising:
a compound having at least one of said blocked isocyanate group and at least one of said epoxy group, which are respectively included in a molecule thereof, or a mixture of a compound having two or more of said blocked isocyanate groups and a compound having two or more epoxy groups; and
at least one selected from the group consisting of said nylon salts (I), (II) and (III) according to claim 1.

3. A curable resin composition comprising:
a compound having two or more isocyanate groups;
a compound having two or more vinyl (thio) ether groups; and
at least one selected from the group consisting of said nylon salts (I), (II) and (III) according to claim 1.

4. A curable resin composition, comprising:
a compound having at least one isocyanate group, at least one vinyl (thio) ether group and at least one epoxy group, which are respectively included in a molecule thereof, or a mixture of a compound having two or more of said isocyanate groups, a compound having two or more of said vinyl (thio) ether groups and a compound having two or more of said epoxy groups; and
at least one selected from the group consisting of said nylon salts (I), (II) and (III) according to claim 1.

5. A curable resin composition comprising:
a compound having two or more free isocyanate groups; and
at least one selected from the group consisting of:
a nylon salt (I) comprises a primary diamine represented by the following general formula (1) and a dicarboxylic acid represented by the following formula (2):
H₂N—R¹—NH₂ (1)
HOOC—R²—COOH (2)
(where R¹ represents a hydrocarbon group having 8 to 37 carbon atoms, in which a nitrogen atom of an amino group is directly bonded to a carbon atom of aliphatic hydrocarbon; and R² represents a linear hydrocarbon group having 8 to 15 carbon atoms; and
a nylon salt (III) comprises a primary diamine represented by the following formula (1) and a monocarboxylic acid represented by the following general formula (4):
H₂N—R¹—NH₂ (1) 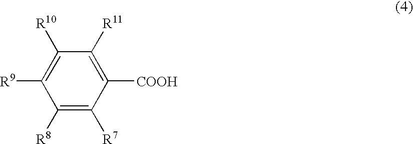
(where R¹ represents a hydrocarbon group having 8 to 37 carbon atoms, in which a nitrogen atom of an amino group is directly bonded to a carbon atom of aliphatic hydrocarbon; R⁷ and R¹¹ independently represent H or OH; R⁸ and R¹⁰ independently represent Cl, Br, I, COOR¹⁷, COR¹⁷, CF₃, CN, SO₂R¹⁷, NO₂ or H; and R⁹ represents Cl, Br, I, COOR¹⁷, COR¹⁷, CF₃, CN, SO₂R¹⁷, H, OH, NR¹⁷₂ or OR¹⁷, at least one of R⁷ to R¹¹ having said substituent except a hydrogen atom, where R¹⁷ represents a hydrocarbon group having 1 to 5 carbon atoms).

6. A curable resin composition comprising:
a compound having at least one epoxy group and at least one free isocyanate group, which are respectively included in a molecule thereof or a mixture of a compound having two or more free isocyanate groups and a compound having two or more epoxy groups; and
said nylon salt (I) or (III) according to claim 5.
